(19) United States
(12) Patent Application Publication
(10) Pub. No.: US 2021/0404380 A1
(43) Pub. Date: Dec. 30, 2021

(54) Carbon-negative combustion through the use of molecular transfer systems and disguisement of gas constituents

(71) Applicant: Daniel Matuszak, Germantown, MD (US)

(72) Inventor: Daniel Matuszak, Germantown, MD (US)

(21) Appl. No.: 17/274,176

(22) PCT Filed: Sep. 7, 2019
(86) PCT No.: PCT/US2019/050113

§ 371 Date: Mar. 7, 2021

Related U.S. Application Data
(60) Provisional application No. 62/728,087, filed on Sep. 7, 2018.

(51) Int. Cl. F02C 3/22; B01D 53/04

(52) U.S. Cl. CPC F02C 3/22; B01D 53/04; F05D 2220/32; B01D 2257/80; B01D 2259/40086; B01D 2257/504

(57) ABSTRACT

Disclosed are methods, processes, systems, and compositions of matter that enable the transfer of targeted constituents from a dilute state to a final concentrated state. Exemplary dilute constituents are carbon dioxide or humidity as found in air or other gases; and exemplary final states, respectively, are purified carbon dioxide or condensed water. Such transfer from dilute sources is understood generally to require more energy consumption as the source phase becomes more dilute in the targeted constituent. The present invention shows how a different governing principle, i.e. reactive disguisement, is applied to create a concentrated final state without relying on heat flow or pressure swings to actively concentrate a targeted constituent. The primary field of invention is chemical separation.

### 1. CROSS-REFERENCE TO RELATED APPLICATIONS

This application claims the priority of provisional application No. 62/728,087, which was filed on 7 Sep. 2018 and entitled “Carbon Capture Processes and Systems Based on Cosorption Phenomena”, by Dr. Daniel Matuszak. This application also claims the priority of international application PCT/US2019/050113, which was filed 7 Sep. 2019 and entitled “Molecular transfer systems and methods for the removal and reactive disguisement of gas constituents”, by same inventor.

### 2. FIELD OF THE INVENTION

The present invention generally pertains to chemical separations systems, carbon capture and storage (CCS) systems, and power generation (PG) systems. This invention relates to sorption systems and processes for the separation and transfer of gas constituents from an original or intermediate phase to a separate phase, including direct air capture systems. This invention also relates to power systems that rely on combustion of carbonaceous fuels to produce electricity and/or heat, and that aim to reduce carbon emissions by means of carbon capture, utilization and storage technologies. This invention further pertains to the combustion of fuels under oxygen-rich conditions, directly as in the Allam Cycle or indirectly as in a solid oxide fuel cell. This invention has the utility of producing carbon-neutral to carbon-negative fossil-fuel fired combustion systems. Further, this invention has utility for reducing the energy penalty associated with the removal of trace levels of CO₂ from mixtures.

### 3. BACKGROUND OF THE INVENTION

Carbon capture technologies have made tremendous progress over the last two decades. Large scale commercial demonstrations have shown the possibility of abating flue gas emissions of carbon dioxide and doing so economically with confidence that some of the carbon dioxide remains in the subsurface. Concurrently, progress in geological storage of carbon dioxide has improved confidence that a tremendous amount of storage space is available in deep saline reservoirs and through carbonization of minerals. A variety of carbon capture, utilization and storage (CCUS) approaches for the power sector are still evolving but most if not all these approaches even when successful are severely limited in that they continue to emit a nontrivial fraction of carbon to the atmosphere. That fraction can vary, but to optimize for economics, power plants equipped with carbon capture are typically designed to achieve a 90% capture rate, meaning that 10% of the carbon that was in the fuel is still emitted to atmosphere despite the 90% that can be stored in geological formations.

In a scenario wherein further carbon emissions are intolerable regardless of their rate, fossil fuels and even some biofuels (vide infra) cannot be combusted unless there is a technology that ensures that their combustion is carbon neutral or carbon negative. In this scenario, fossil-fueled power generation must capture and store 100% of the carbon that was in the fuel (at a minimum). Unfortunately, a well-known thermodynamic limitation concerning the entropy of mixing at dilute concentrations precludes this possibility because (i) it takes an infinite amount of work to remove 100% of a constituent from a chemical mixture, and because (ii) the amount of required work sharply increases as the separation approaches the unattainable limit of full removal.

To ameliorate this challenge, direct air capture (DAC) with geological storage, among other negative emissions technologies (NETs), are promising possibilities for balancing and then reversing the carbon cycle but these approaches do not produce electricity. They are capable of offsetting carbon emissions from the power and transportation sectors but executing these approaches at the gigatonne (Gt) scale remains out of reach at the time of this application and in the foreseeable future (the U.S. emits on the order of 5 Gt CO₂ per year). On barrier to deployment is the above-mentioned thermodynamic limitation associated approaching the limit of full removal from a mixture—this limitation has made DAC much less appealing than post-combustion carbon capture from natural gas and coal fired power plants (see FIG. 2, “Minimum work required for CO2 capture based upon initial gas concentration . . . ” in J. Wilcox, R. Haghpanah, E. C. Rupp, J. He and K. Lee, Annu. Rev. Chem. Biomol. Eng., 2014, 5, 479-505). In the foreseeable future, for negative emissions approaches to balance carbon emissions from the power and transportation sectors, power and transportation would need to cease using fossil fuels—that is unlikely due to economics, policy, and limitations in the supply chains for critical materials needed to establish a fully renewable energy system. Therefore, there is a need for carbon-negative power systems and transportation systems. This invention addresses the former. (Transportation systems may eventually become electrified and hence be powered by carbon-negative power systems.)

Bioenergy with carbon capture and storage (BECCS) is one concept for producing power in a potentially carbon negative way, if done properly. For example, wood-fired power generation with carbon capture and storage (CCS) is one such BECCS approach—the wood is a form of air-captured CO₂, which is released upon combustion in a BECCS plant, and subsequently captured and stored in a geological reservoir. However, the BECCS plant would still emit a fraction of the carbon because 100% capture is not economical due to a thermodynamic limitation (vide supra). Hence, proper land management practices would need to be established and strictly enforced because cutting down trees to produce power with a 90% carbon capture and storage rate is still a means of emitting 10% of the carbon that was safely, indefinitely, and quite nicely stored in the form of wood. There are other negative consequences of deforestation that would need to be mitigated. Without exquisite control of land management practices, BECCS would be highly unlikely to be carbon negative in the forthcoming decades. Forests would need to be started or expanded today for BECCS systems to be powered in the future in at least a carbon-neutral way. To address this limitation of BECCS, alternative technical approaches are needed for carbon-negative power generation—specifically, approaches for carbon-negative fossil-fuel based power generation. This invention is one such approach.

Yet another concept for producing power in a potentially carbon negative way is to offset the uncaptured emissions from a power sector that is equipped with CCS. If such a sector were to capture and store 90% of the carbon originating in the fuel and to release 10% of it to atmosphere, then a DAC with carbon storage (DACCS) approach can address the latter and thus lead to an overall net-neutral carbon flow from this hypothetical power sector. Further, if more DACCS capacity was deployed then the carbon flow from the power sector would be net-negative, thus providing carbon-negative fossil-fuel based power generation on an aggregate basis. Even if this were achieved, there would be a lack of carbon-negative fossil-fuel based power generation on an individual power plant basis.

This invention concerns the production of carbon-negative fossil-fuel based power generation at an individual power plant. The approach involves a specific merger of DAC, Power Generation, and Carbon Storage (DACPGS) and is driven by the discovery that the integrated system has benefits that are not present in the sum of the individual parts (vide infra).

Relevant prior art includes capture systems that employ sweep gases. The patent application for Lackner's humidity-swing process, US2009/0232861A1, briefly mentions using “possibly an inert sweep gas” that helps form a mixture of water vapor, CO2, and the sweep gas itself. The partial pressure of the inert sweep gas is adjustable by altering its flow rate. Such a sweep gas is designed to carry CO2 and humidity so that a liquid-phase wash fluid is avoided. A major limitation of sweep gases is the potential need for their removal through subsequent steps. While moisture can be condensed (with some loss of CO2), the inert sweep gas remains a diluent of CO2. For some applications, such as feeding greenhouses, the sweep gas may be acceptable so long as its cost to dispose or to recycle is not excessive. In other applications that require high CO2 purity, the inert sweep gas must be removed through an approach such as a membrane separation.

Other relevant prior art includes steam purging assistance, such as in pressure or vacuum swing adsorption (EP1142623A2). Steam purging is a thermal regeneration method that appear similar to employing sweep gases. However, unlike the sweep gases mentioned above, the primary purpose of steam purging is the transfer of thermal energy from the hot gas to drive the desorption. Direct contact of steam with a cooler adsorbed phase typically leads to condensation unless the steam is superheated sufficiently as in patent EP1142623A2. Regardless of whether vapor condensation occurs, the purging of an adsorbent (or solvent) with a hot purge gas involves the upstream use of a heat exchanger that transfers heat from a combustion or other heat source to the purge gas. This may create an economic disadvantage due to the required capital equipment and variable operating costs associated with vaporizing and superheating a fluid. Therefore, approaches that do not require significant thermal input and associated heat exchange equipment to accomplish the regeneration of a sorbent or solvent would be useful and are needed.

Other relevant prior art includes membrane systems that employ a permeate sweep feature, as in MTR's process for CO2 removal from combustion gases—subject of U.S. Pat. No. 7,964,020B2. The upstream side of the membrane is in contact with a CO2-rich combustion gas, while the downstream (permeate) side is in contact with a moving sweep stream: “a sweep gas of air, oxygen-enriched air or oxygen [ . . . ] flows across the permeate side.” The sweep stream accepts the selectively permeating CO2 from the membrane, and the resulting CO2-enriched sweep stream is recycled toward the front of the combustion process either directly or after mixing with incoming air. The CO2-enriched sweep stream may also be processed by a secondary carbon capture system, e.g. one that employs a solvent. By recycling CO2 into the combustor at the dilutions conceived in U.S. Pat. No. 7,964,020B2, the overall effect of this membrane approach is to increase the concentration of CO2 in the combustion gas that is contacted by the membrane as described, thus improving the driving force for separation and makes the use of membranes more economical. While this membrane approach is reasonable for conventional power systems that burn coal or natural gas, there are at a few major limitations in this MTR approach as described next.

First, the utility of the MTR approach is exclusively directed at combustion systems that use air (not pure oxygen) as the oxidizing stream. An oxygen-fed combustion (“oxycombustion”, e.g. the Allam Cycle) produces combustion gas that mostly consists of CO2 and H2O, of which the latter is condensed and separated very easily by cooling, leaving a water-depleted gas with a very high CO2 purity. Thus, a membrane separation has little or zero utility in oxycombustion processes. A CO2/N2 membrane separation (as in U.S. Pat. No. 7,964,020B2) would have even less utility for oxycombustion processes because the nitrogen was removed far upstream by an air separation system. Hence, MTR's membrane approach is not suitable for treating CO2-laden gas from oxycombustion processes.

Second, the air-sweep configuration in U.S. Pat. No. 7,964,020B2 results in counter-permeation of sweep gas components (O2, N2) toward the combustion gas, i.e. in the direction opposite of CO2 permeation. This is not a concern because the combustion gas already contains N2 and O2 to some extent—these gases do not have adverse effects upon release to the environment, so an increase in their concentration due to counter-permeation from the sweep stream does not merit great discussion at least in the referenced patent. However, if a more exotic sweep stream was employed, the counter-permeation of its components could become an issue. For example, if synthesis gas (“syngas”, a mixture of carbon monoxide and hydrogen) was used as the sweep gas, the counter-permeation of syngas components could become fatal for bystanders after release from the power plant's stack, depending on dispersion effects. As another example, if methane was used as the sweep gas, the counter permeation of methane and its subsequent release with combustion gases would exacerbate the global-warming problem because CH4 is a 25-fold more potent greenhouse gas than CO2. Thus, the sweep stream in the referenced MTR approach is limited to air or enriched air. Economically only the former is the practical choice—enriching air requires an air separation system, which is more valuable if used for oxycombustion; but an oxycombustion process would preclude the MTR membrane approach as discussed earlier, because a CO2/H2O mixture is very easy to separate. Evidently, the MTR approach is primarily focused on using air as the sweep gas. Any reference to using enriched oxygen or oxygen aims to address concerns that the MTR process will make the combustion itself less efficient by diluting the O2 entering the combustor via the recycling of CO2 from the back end of the power system. The MTR approach, while elegant, is not suitable for use with reactive or otherwise harmful sweep gases, such as methane or syngas.

Third, the permeate-sweep approach is designed to maximize the driving force for CO2 permeation through the MTR membrane (vide supra), so that less membrane area is required to remove a given amount of CO2 from a unit of combustion gas. The utility of this approach is very high because membrane systems are modular in nature and lack the economies of scale that a power plant relies on—getting the most benefit from each unit of membrane surface is essential and well-achieved by MTR's permeate-sweep approach at least in concept. Thus, the permeate sweep approach is effective at addressing a key mass-transfer problem for membrane-based CO2 capture from combustion systems, but it is not meant to address other problems. The utility of the MTR permeate-sweep approach is very specific, conferring the main benefit of reducing membrane surface area and associated capital expense.

Finally, as a membrane approach for carbon capture on conventional fossil-fuel fired power systems, the MTR approach captures less than 100% of the incoming carbon due to the thermodynamic limitation described earlier. Most membrane approaches are designed to capture 90% of the carbon dioxide from the flue gas, or another fraction that is significantly lower than 100%. Hence, these approaches are not capable of creating the benefit of carbon-neutral to carbon-negative PG.

Other relevant prior art includes systems that employ displacement purge streams. Displacement purge is similar to the humidity-swing DAC process of Infinitree (U.S. Pat. No. 8,337,589B2), which does not rely on swings in temperature or vacuum and is based on the work of Klaus Lackner. The earlier invention by Keefer et al. (US 2004/0011198A1) provides a more general disclosure of how displacement purge assists regeneration: “For enriching a component A of a feed gas mixture containing components A and B, an adsorbent material over which component B is more readily adsorbed and component A is less readily adsorbed may be provided [ . . . ] the total pressure may be kept approximately constant in the regeneration step, while component B is desorbed by a third preferably less readily adsorbed component C, which was not part of the feed gas mixture”. To make the connection to Infinitree's approach, consider A=N2, B=CO2, and C=H2O where C is a component of air. Keefer et al. provide the example of A=H2, B=CO2, and C=O2 where C is a component of air—displacement purge uses air “or any oxygen-containing gas with oxygen appearing as a component C”. The invention of Keefer et al. is concerned primarily with the hazards of cross-contamination between A and C (hence it introduces buffer steps), but it discards the spent displacement purge that ultimately contains B and C: “dilute carbon dioxide (component B) is to be separated, typically for rejection directly to the atmosphere, and with air or preferably nitrogen-enriched air as the displacement purge stream containing oxygen (component C).” The utility that the invention of Keefer et al. provides is the attainment of a purer H2 stream (component A) through the removal of CO2 (component B)—the purer H2 stream has a better heating value hand hence is relevant to “advanced power generation technologies such as solid oxide fuel cells, [wherein the] overall efficiency of the power generation system can be unexpectedly boosted by [the invention of Keefer et al.] which will enable the separation and recycle of enriched hydrogen to the fuel cell anode while diluting carbon dioxide into the atmosphere” (US 2004/0011198A1). Keefer et al. teach how CO2 may be removed from H2 but they do not teach how to attain a carbon-negative combustion or the resultant carbon-negative PG.

Other relevant prior art is the use of displacement purge that is reactive (reactive sweep gas) as taught by Pruet (US 2005/0284290A1). This is similar to the MTR approach (vide supra). Pruet's invention is concerned with removal of moisture from a Fischer-Tropsch (FT) product stream, which is a mixture of hydrocarbons. The FT stream is contacted with a ceramic separation membrane, and in “a preferred embodiment, a hydrogen-rich sweep gas is fed to the downstream permeate side of the separation membrane to thereby recover/remove the water, generally a vapor, from the membrane. The recovered water can then be used as is or forwarded for purification, e.g., preferably to a thermal oxidizer. The use of a thermal oxidizer is preferred to insure removal of all contaminants from the reaction water” (US 2005/0284290A1). This invention's main benefit or “result is an overall cost effective and energy efficient Fischer-Tropsch process, which also allows the useful recovery of water from the product streams.” Thermal oxidizers typically mix fuel and air in a combustion chamber to create a flame that burns a waste gas so that any hazardous pollutants are destroyed by the flame prior to being emitted to atmosphere. The waste gas is a mixture of H2O, H2, and FT hydrocarbons that permeated the ceramic membrane in Pruet's example. Pruet's invention teaches a water-removal approach to attain better FT product purity. However, it does not teach an approach for carbon-negative combustion or resultant carbon-negative PG. Both CO2 and H2O are effluents of Pruet's thermal oxidizer, regardless of whether a condenser is placed downstream of the oxidizer for recovery of at least water.

It is relevant to note that the hydrogen atoms in the produced water that is recovered downstream of the thermal oxidizer cannot be distinguished as originating in the moist FT product or in the hydrogen sweep, which is passed on the permeate side of the membrane. Herein this is referred to as “reactive disguisement” because the H atoms cannot be distinguished. In Pruet's example, in the context of a mixture containing H2 and H2O, the reactive disguisement of hydrogen atoms in H2 occurs in a thermal oxidizer to provide the benefit of creating more H2O (while preventing hazardous emissions concurrently). However, with H2 being an extremely valuable feedstock relative to water, the decision to “reactively disguise” its H atoms by incineration in a thermal oxidizer does not make economic or practical sense. That is why a subsequent embodiment of Pruet's invention avoids a thermal oxidizer: referring to Pruet's FIG. 2, “Water vapor 50 which permeates the ceramic membrane 100 is fed to a condenser 400 and a separation unit 500. A hydrogen-rich tail gas 60 and purified water 70 are recovered from the separation unit 500. At least a portion of the hydrogen-rich tail gas 60 may serve as a source of the hydrogen-rich sweep gas 20” (US 2005/0284290A1). Hydrogen H2 is recovered and reused so. Overall, reactive disguisement of H2 by incineration does not confer a strong benefit or utility, relative to the benefit for capturing and reusing the H2 in Pruet's primary innovation (the use of a sweep gas to drive permeation of water in the dehydration of an FT product). Pruet teaches an enhanced membrane separation process, but does not teach how to attain a carbon-negative combustion or a resultant carbon-negative PG.

Pruet did not teach or even mention the following, but it is interesting and relevant to observe that the oxidation of H2 to H2O, in the context of a mixture that contains both, avoids the need to separate H2 and H2O. If the separation of H2 and H2O was a difficult and important one, the oxidation and resultant reactive disguisement of H2 would have been valuable. However, the separation of H2 and H2O is an extremely easy separation to achieve considering the large difference in boiling points for H2 and H2O (−252.9° C. and 100° C. respectively), unquestionably leading to Pruet's subsequent embodiment for H2 recovery, which avoids thermal oxidation. The thermal oxidation confers the benefit of producing water and eliminating hazardous pollutants, albeit at the expense of destroying valuable H2 and auxiliary fuel. Pruet does not teach that thermal oxidation (and associated reactive disguisement of hydrogen) confers any additional benefit or utility. On the other hand, in the present invention, reactive disguisement of other compounds can confer an unforeseen additional benefit and utility.

Other relevant prior art includes power systems and processes that use purified oxygen as the oxidizer for the combustion, including solid oxide fuel cells (SOFCs) and power systems that employ the Allam Cycle as invented by Allam et al. in U.S. Pat. No. 8,596,075B2 and thereafter improved upon to be a semi-open cycle and is now referred to as the Allam-Fetvedt cycle (Allam et al. “Demonstration of the Allam Cycle: An update on the development status of a high efficiency supercritical carbon dioxide power process employing full carbon capture”, Energy Procedia issue 114, 2017, pp. 5948-5966). This invention enables high-efficiency fossil-fuel based PG with carbon capture, utilization, and storage. Hence, it is a carbon-efficient power system, but it is not a carbon-negative power system, at least in the form depicted in FIG. 1 of Energy Procedia 114 (2017) 5948 because the effluent water (“H2O Out” in FIG. 1) is loaded with CO2 at a fugacity of approximately 29 bar and therefore leads to carbon leakage from the system boundary. Hence, PG systems employing the Allam-Fetvedt cycle or variant oxygen-fueled cycles may approach the limit of carbon-neutrality as they managed to contain CO2 leakage, but they are not capable of being carbon negative except if operating as a BECCS plant with pristine land management practices.

In summary, there is an acute need for carbon-negative power generation, but the current and emerging low-carbon PG technologies are unable to fulfill that need without offsets from commensurate operation of negative emissions technologies (NETs) such as direct air capture (DAC) with carbon storage and sequestration. While a power sector that employs both low-carbon PG technologies with sufficient NETs may attain a carbon-neutral or carbon-negative state, there is no technological approach to attain carbon-negative fossil-fuel based PG on an individual power plant basis. This invention teaches that a specific integration DAC with PG and Carbon Storage (i.e., DACPGS) can confer the benefits of a concept herein termed “reactive disguisement” that originates in the PG portion and relays benefit to the DAC portion, overall leading to the possibility of carbon-negative fossil-fuel based PG. The concept of reactive disguisement relies on the use of sweep gases (a.k.a. displacement purge) and a chemical conversion in a specific power generation system. Sweep gas concepts have been employed in various applications, but none of them confer the benefit of carbon-negative fossil-fuel based PG. This invention illustrates how to realize such a benefit.

### 4. BRIEF SUMMARY OF THE INVENTION

The present invention provides a process for removing CO2 from air; creating a mixture of CO2 and O2; sufficiently concentrating the CO2 while retaining a balance of O2; relaying the CO2-O2 mixture toward the combustor of an oxygen-fueled combustor that is part of a semi-open CO2-based power cycle; combusting the CO2-O2 mixture with a mixture of hydrocarbons; separating, recycling, and exporting the resultant CO2 and H2O as in the semi-open Allam-Fetvedt cycle. The combustor may be fueled by natural gas, coal or biomass, but for the purpose of this disclosure the combustor is fed with a gaseous hydrocarbon fuel with CH4 as the primary constituent as in the natural-gas fired Allam-Fetvedt cycle.

In one embodiment of the present invention, air is bought into contact with an adsorbent that selectively removes CO2 from air. Once the adsorbent reaches its capacity for CO2 under atmospheric conditions, the adsorbent is isolated from atmospheric air and a reactive sweep gas consisting mostly of oxygen at elevated temperature is brought into contact with the adsorbent. This oxygen stream desorbs the CO2 that was removed from air. Once the adsorbent is depleted to its original CO2 capacity, the adsorbent is isolated from the oxygen stream and air flow is reintroduced to the adsorbent to repeat the cycle. This represents one separation stage.

In other embodiments, to concentrate the CO2 further, additional separation stages are employed. The warm oxygen stream containing desorbed CO2 from the first separation stage is cooled to ambient temperature while being directed toward a second stage containing an adsorbent that selectively removes CO2 from the oxygen-CO2 mixture. Once the adsorbent of the second stager reaches its capacity for CO2, the adsorbent is isolated from the oxygen-CO2 stream. A second stream of reactive sweep gas consisting mostly of oxygen at elevated temperature is brought into contact with the adsorbent of the second stage, desorbing the CO2 that was removed from the first oxygen-CO2 stream. Once the adsorbent of the second stage is depleted to its original CO2 capacity, the adsorbent is isolated from the second oxygen-CO2 stream. Hence, the adsorbent is reintroduced to the first oxygen-CO2 mixture to repeat the cycle. This represents the second stage. Third and fourth stages may follow to concentrate the CO2 further to a range of 33% to 50% CO2 with the balance being O2 (vide infra).

In one embodiment, the emergent oxygen stream that was enriched with CO2 (emergent O2-CO2 stream) is pressurized using a compressor to a final pressure (˜320 bar) that enables mixing into the purified oxygen stream from the air separation unit feeding the combustor of the Allam-Fetvedt cycle. In another embodiment, the emergent O2-CO2 stream is pressurized using a compressor to a final pressure (˜100 bar) that enables mixing into the CO2 stream being recycled toward the combustor after a fraction was split off for export.

In another embodiment, compression of the emergent O2-CO2 stream is performed in part by physical contact with the combustion-derived water that condenses at a pressure of 29 bar—this pressurizes the emergent O2-CO2 stream from circa 1 bar to 29 bar. The unexpected benefit of such compression is that the emergent O2-CO2 stream becomes further enriched in CO2 from 33% to as high as 60% CO2 because of the equilibration of the gas phase with effluent combustion-derived water that contains CO2. The upgraded O2-CO2 stream is then compressed to a final pressure that is suitable for mixing into the CO2 stream being recycled to the combustor.

In one embodiment, reactive disguisement of carbon from within a gaseous hydrocarbon mixture (that consists mostly of CH4) occurs by combusting a mixture consisting of hydrocarbons, CO2, O2, and H2O hence generating a final mixture consisting of CO2 and H2O. Hydrocarbons and O2 are no longer present in this final mixture when a stoichiometric ratio of hydrocarbons and O2 is used, hence providing the key benefit of bypassing the well-known thermodynamic limitation concerning the entropy of mixing that prevents full removal of one constituent from a mixture (vide supra). This conversion results in reactive disguisement of carbon atoms and oxygen atoms—they cannot be traced to their original molecular source (hydrocarbon, CO2 removed from air, or O2). In another embodiment, excess oxygen is used leading to a final mixture of CO2, O2, and H2O—in this case, the hydrocarbons are fully removed from the original mixture and the result is reactive disguisement of carbon atoms. The benefit of reactive disguisement in the DACPGS configuration is the realization of a less intensive DAC operation that can halt itself at a significantly lower CO2 purity (e.g. 33% CO2, balance O2) and be ready for export to utilization or sequestration operations. On the other hand, an independent DAC operation would be required to purify CO2 to 99% or higher in order to export to utilization or sequestration operations. Being that the final CO2 purity of a DAC operation is a major cost driver, the reactive disguisement approach in a DACPGS configuration confers a major benefit to the DAC operation. In turn, the DAC operation confers the benefit of carbon-negative status to the PG operation.

In most embodiments, the final mixture of CO2 and H2O is depressurized through turbomachinery that generates power, and then it is sufficiently cooled at a pressure on the order of 30 bar so that the majority of the H2O condenses and can be removed. This leaves a high purity CO2 stream that is ready in part for export and for recycling to the combustor.

In preferred embodiments, a composition for the reactive sweep gas within the DAC operation is essentially pure oxygen. In some embodiments, the oxygen is obtained from an air separation unit. In other embodiments, the oxygen is obtained from a water electrolysis process. However, yet in other embodiments, a composition for the reactive sweep fluid includes a hydrocarbon gas such as methane, ethane, propane, natural gas, synthesis gas, or another hydrocarbon gas mixture. In another embodiment, the reactive sweep gas is carbon monoxide or synthesis gas, i.e. a mixture of carbon monoxide and hydrogen. In yet another embodiment, the reactive sweep gas is hydrogen.

In accordance with yet another aspect of the presently disclosed inventive concepts, a method of non-thermally regenerating a liquid phase containing captured constituents (in a DAC operation) includes contacting said liquid phase with a reactive sweep gas. The contacting of phases occurs by bubbling the reactive sweep gas through the liquid phase; alternatively, the liquid phase may be atomized and dispersed through the reactive sweep gas phase prior to a collection step that removes the regenerated liquid. The liquid phase is a solvent such as a hydroxide solution such as potassium hydroxide, an amine solution such as ethanolamine, ocean water, an ionic liquid, or another liquid that has a physical and/or chemical affinity for the captured constituents. The regeneration may be conducted non-thermally, but in practical cases the liquid phase is heated in order to increase the driving force for removal of captured constituents. The temperature of the reactive sweep gas may equal ambient temperature, or it may be elevated to match the solvent's temperature.

In yet another embodiment, the spent reactive sweep fluid is chemically converted at the anode of a fuel cell, as in a solid oxide fuel cell using an anion exchange membrane allowing migration of oxygen atoms from the cathode, which is in contact with air. In one use case, the carbon dioxide is captured from regular air. In another use case, the carbon dioxide is captured from a building's HVAC exhaust. In yet another use case, the carbon dioxide is captured from the flue gas of ordinary combustion. In yet another use case, the carbon dioxide is captured from shifted synthesis gas.

In accordance with yet another aspect of the presently disclosed inventive concepts, a method of operation includes capturing constituents from a gas phase by flowing the gas upward over a sorbent such that it attains a fluidized bed or bubbling bed configuration, subsequently directing flow in the downward direction to attain a packed bed configuration, replacing the initial gas phase with a reactive sweep gas that continues to flow downward, and switching the gas phase composition and direction of flow back to the original state to repeat the cycle. In one embodiment, the packed bed configuration attained through downward flow of reactive sweep gas enables the dynamic pressure adjustment method; while the fluidized or bubbling bed configurations enhance the efficiency of gas flow during the initial capture. In another embodiment, the bed configuration remains packed regardless of the sweep gas or direction of flow.

The removal of dilute components from mixtures is considered difficult in chemical engineering practice because the minimum thermodynamic work, calculated from the mixture entropy, increases as the desired component's mole fraction decreases. The reactive disguisement approach employing the reactive sweep gas overcomes this challenge.

Other aspects and advantages of the present invention will become apparent from the following detailed description, which, when taken into conjunction with the drawings, illustrate by way of example the principles of the invention.

Among other factors, the inventive concepts are based upon the following discoveries: (1) that in a DACPGS configuration the DAC operation can halt at significantly lower CO2 purities than otherwise would be needed for an independent DAC operation that produces CO2 for sequestration; and (2) that in a DACPGS configuration the effluent combustion water can be used to pressurize and further enrich the emergent CO2-O2 stream exiting the DAC operation. The result the DACPGS configuration is a cost effective and energy efficient DAC operation and the prospect of a carbon-negative PGS operation.

### 5. BRIEF DESCRIPTION OF THE DRAWINGS

FIG. 1A is a schematic diagram of a capture unit, which is enabled for unidirectional gas flow through a stationary phase.

FIG. 1B is a schematic diagram of a capture unit, which is enabled for bidirectional gas flow through a stationary phase.

FIG. 2A is a pressure-enthalpy diagram for oxygen, illustrating thermodynamic transitions.

FIG. 3B is a schematic diagram showing gas production from a water electrolysis unit, which provides reactive sweep gas to the capture unit.

FIG. 4 is a schematic diagram showing a dynamic pressure adjustment system that employs a high-pressure gas such as pipelined natural gas.

FIG. 5A is a schematic diagram that shows the capture unit, which uses an oxygen stream as a reactive sweep stream in order to produce a spent reactive sweep stream that ultimately is combusted.

FIG. 5B is a schematic diagram that shows the capture unit 1B, which uses a methane stream 15 as a reactive sweep stream in order to produce a spent reactive sweep stream 5 that ultimately is converted by reaction in a fuel cell.

FIG. 6 is a schematic diagram of a capture unit which is enabled for bidirectional gas flow through a stationary phase and for full fluidization.

FIG. 100 is a simplified block flow diagram of a gas-fed Allam Cycle.

FIG. 130 is a simplified block flow diagram of a gas-fed Allam Cycle that is modified by the addition of Post-Emission Capture (PEC) system.

FIG. 135 is a simplified block flow diagram of a modified gas-fed Allam Cycle that is further modified by the addition of PEC system 130 in a highly preferred embodiment.

FIG. 140 is a simplified block flow diagram of a modified gas-fed Allam Cycle that is further modified by the addition of PEC system.

FIG. 150 is a simplified block flow diagram of a modified gas-fed Allam Cycle that is further modified by the addition of an alternative PEC system that accepts a hydrocarbon (HC) inlet stream and that produces a hydrocarbon feed (HCF) stream for the combustor.

FIG. 160 is a simplified block flow diagram of a modified gas-fed Allam Cycle that is further modified by the addition of an alternative PEC system that accepts the hydrocarbon (HC) stream into the NG stream.

FIG. 170 is a simplified block flow diagram of a portion of the coal-fed Allam Cycle.

FIG. 175 is a simplified block flow diagram of a portion of a coal-fed Allam Cycle that is modified by the addition of Post-Emission Capture (PEC) system.

FIG. 180 is a simplified block flow diagram of a portion of a modified coal-fed Allam Cycle that is further modified by the addition of PEC system.

FIG. 185 is a simplified block flow diagram of a portion of a modified coal-fed Allam Cycle that is further modified by the addition of an alternative PEC system that accepts a hydrocarbon (HC) inlet stream and that produces a hydrocarbon feed (HCF) stream for the combustor.

FIG. 190 is a simplified block flow diagram of a portion of a modified coal-fed Allam Cycle that is further modified by the addition of an alternative PEC system 130 that accepts the hydrocarbon (HC) stream 210 into the syngas stream.

FIG. 195 is a simplified block flow diagram of a portion of a modified coal-fed Allam Cycle that is further modified by the addition of an alternative PEC system 130 in a highly preferred embodiment.

FIG. 200 illustrates the inputs to and subsystems of PEC system.

FIG. 210 illustrates the inputs to and subsystems of PEC system, with a modified operating procedure.

FIG. 220 illustrates the inputs to and subsystems of PEC system, with a modified sequence of introduced constituents.

FIG. 230 illustrates the inputs to and subsystems of a PEC system.

FIG. 240 illustrates the inputs to and subsystems of a PEC system, with a modified operating procedure.

FIG. 300 illustrates an arrangement of subunits for a basic subsystem of a PEC system.

FIG. 310 illustrates an arrangement of subunits for a PEC subsystem that employs a separate dehydration step.

FIG. 320 illustrates an arrangement of subunits for another PEC subsystem that employs a separate dehydration step.

FIG. 330 illustrates a parallel arrangement of subsystems that enable reduction of pressure loss (pressure gradient) across each subsystem.

FIG. 400 illustrates one embodiment of a capture subunit.

FIG. 410 illustrates another embodiment of a capture subunit.

FIG. 420 illustrates yet another embodiment of a capture subunit.

FIG. 430 illustrates yet another embodiment of a capture subunit.

FIG. 440 illustrates another embodiment of a capture subsystem.

FIG. 500 illustrates an arrangement of subunits for a PEC subsystem that employs a pressure and thermal management method.

FIG. 510 illustrates an arrangement of subunits for a PEC subsystem that employs an alternative pressure and thermal management method.

FIG. 520 illustrates an arrangement of subunits for a PEC subsystem that employs an alternative pressure and thermal management method described in association with FIG. 510.

FIG. 550 illustrates the arrangement of parallel systems that utilize the method described in association with FIG. 520 for the purpose of providing natural convection drive.

FIG. 560 illustrates the use of a heat pipe for the purpose of transferring heat.

FIG. 900 is a simplified block flow diagram of an alternative Post-Emission Capture (PEC) process that is suitable for a CCS-enabled power plant.

FIG. 910 illustrates the inputs to and subsystems of a PEC system, which is associated with FIG. 900.

FIG. 1000 is a simplified block flow diagram for a conventional solvent-based carbon dioxide capture process.

FIG. 1010 is a simplified block flow diagram for a modified solvent-based carbon dioxide capture process, wherein a natural gas stream is used to desorb CO2 from the regenerator.

FIG. 1020 is a simplified block flow diagram for a modified solvent-based carbon dioxide capture process, wherein a natural gas stream is used to partially desorb CO2 from a primary regenerator.

FIG. 2100 is a schematic that illustrates the possibilities for and logic of reactive disguisement.

FIG. 2200 is a block flow diagram that illustrates an adsorbent-based DAC system with four stages.

FIG. 2250 is a schematic that shows the sequence of exchanges among the four stages of the adsorbent-based DAC system.

### 6. DETAILED DESCRIPTION OF THE INVENTION

The following description is made for the purpose of illustrating the general principles of the present invention and is not meant to limit the inventive concepts claimed herein. Features described herein can be used in combination with other described features in each of the various possible combinations.

In accordance with one aspect of the presently disclosed inventive concepts, a method of non-thermally regenerating a stationary phase containing constituents that were captured from a second phase (i.e., the initial gas phase containing targeted constituents) includes contacting said stationary phase with a reactive sweep gas. The reactive sweep gas is capable of being chemically oxidized or reduced, or otherwise converted. The stationary phase is a sorbent such as a zeolite, metal organic framework (MOF), polymer, carbohydrate, or carbonaceous material. The targeted constituents become and are referred to as captured constituents—they are one or more gas species that have an affinity for the stationary phase. Specifically, carbon dioxide and/or moisture are targeted constituents in the examples of the inventive matter provided herein.

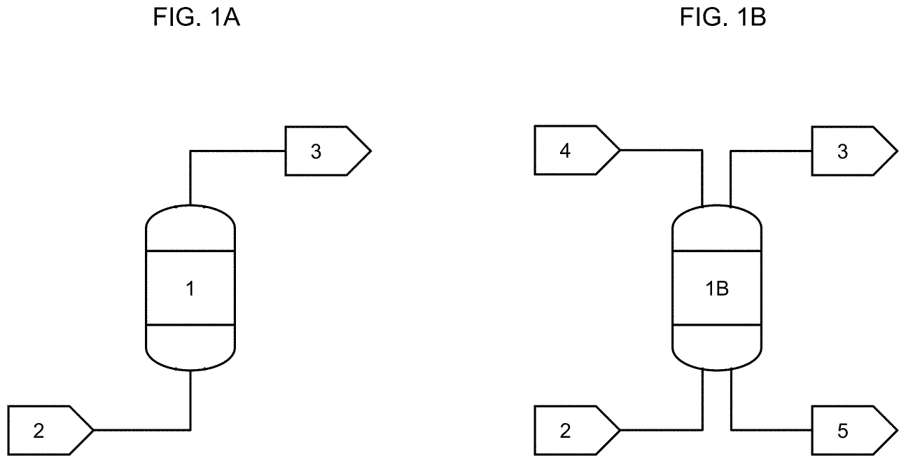

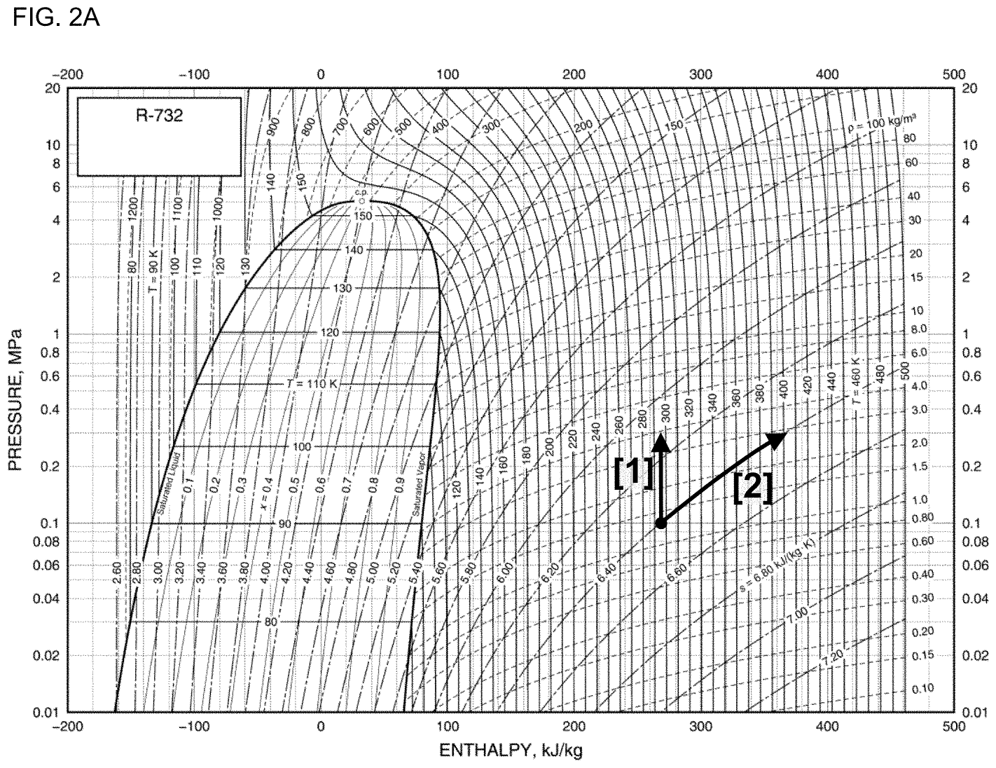

FIG. 1A is a schematic diagram of a capture unit, i.e. Element 1, which is enabled for unidirectional gas flow through a stationary phase. Element 1 is a vessel (a.k.a., Vessel 1) that consists of a confined stationary phase. The stationary phase is a packed bed consisting of one or more sorbent materials. The bed operates in either a stationary mode or a bubbling mode, depending on the particle size distribution and gas velocity through the bed. Element 2 is the inlet gas stream and Element 3 is the outlet gas stream for Vessel 1—they are also termed Stream 2 and Stream 3, respectively. In the configuration shown in FIG. 1A, the gas flow occurs upward (i.e. against gravity) through the column, which is vertically oriented with respect to ground. In this configuration, the composition of Stream 2 alternates between an initial gas that delivers targeted constituents to the stationary phase (capture step) and a reactive sweep gas that receives the targeted constituents from the stationary phase (regeneration step). During the capture step, Stream 2 is relatively rich in the targeted constituents while Stream 3 is relatively lean in the targeted constituents, until the stationary phase becomes saturated. After that time, the composition of Stream 2 is switched to deliver the reactive sweep gas. The reactive sweep gas flows through the stationary phase, receiving the targeted constituents that were adsorbed, and exits as Stream 3 until there is no measurable indication of targeted constituents in Stream 3. After that time, the composition of Stream 2 is switched once again to deliver the initial gas containing targeted constituents.

FIG. 1B is a schematic diagram of a capture unit, i.e. Element 1B, which is enabled for bidirectional gas flow through a stationary phase. Element 1B is also known as Vessel 1B and it contains a confined stationary phase of sorbent that may become partially fluidized as a bubbling bed due to the upward flow of inlet gas stream 2. Stream 2 delivers an initial gas containing targeted constituents to the stationary phase, and Stream 3 removes a gas that is leaner in targeted constituents until the stationary phase becomes saturated and the composition of Streams 2 and 3 become identical. After that time, Streams 2 and 3 are closed using valves (not shown), and then Streams 4 and 5 are opened to allow the flow of reactive sweep gas in the downward direction. The transition from upward flow to downward flow reduces the macro-scale porosity of the stationary phase, creating more resistance to flow and thereby increasing the pressure drop across the stationary phase.

In preferred embodiments, the reactive sweep gas is pure oxygen. Purified oxygen is commercially available in large volumes by using demonstrated air separation techniques, e.g. cryogenic methods, and to some extent through adsorption or anion exchange techniques employing solid oxide materials. Noteworthy also is the generation of oxygen at the anode of a water electrolyzer (which concurrently generates hydrogen at the cathode). In accordance with one aspect of the presently disclosed inventive concepts, a composition for the reactive sweep fluid includes a hydrocarbon gas such as methane, ethane, propane, natural gas, synthesis gas, or another hydrocarbon gas mixture. Hydrocarbon gases are easily attained from oil and gas production and refining, but biological sources including landfills are noteworthy. In another embodiment, the reactive sweep gas is carbon monoxide or synthesis gas, i.e. a mixture of carbon monoxide and hydrogen. Synthesis gas (a.k.a. syngas) is attainable through steam-methane reforming or the gasification of coal or biomass. Noteworthy, on the other hand, is the generation of carbon monoxide by electrolysis of carbon dioxide as in the electrolyzers made by Dioxide Materials and 3M. In yet another embodiment, the reactive sweep gas is another oxidizing agent. In yet another embodiment, the reactive sweep gas is hydrogen. Most of the World's hydrogen is produced by steam-methane reforming with a water-gas shift stage.

In accordance with another aspect of the presently disclosed inventive concepts, a method of purging harmful or toxic matter from the stationary or solvent phase includes contacting the stationary or solvent phase with oxygen that is subsequently combusted. For reactive sweep gases other than oxygen, such as gases containing potent greenhouse gases (methane) or highly toxic species (carbon monoxide), the stationary phase or solvent must be flushed with oxygen prior to restarting the cycle of capturing targeted constituents from air.

In accordance with another aspect of the presently disclosed inventive concepts, a method of enhancing the above-disclosed non-thermal regeneration includes dynamically adjusting the pressure of the reactive sweep fluid to promote greater desorption of captured constituents per volume of the reactive sweep fluid used to effect the desorption. The dynamic pressure adjustment includes either the increase or decrease of pressure at a controlled rate, depending on the characteristics of the reactive sweep fluid. In most practical cases the reactive sweep gas' pressure is increased in order to enhance the desorption of the captured constituents—this is opposite to contemporary vacuum swing processes that reduce pressure to enhance desorption. The dynamic pressure adjustment can be isothermal or thermal depending on the rate and duration of pressure change, but a greater overall efficiency is attainable when the bulk gas is pressurized isothermally or near isothermally so that unnecessary heat generation and losses are limited.

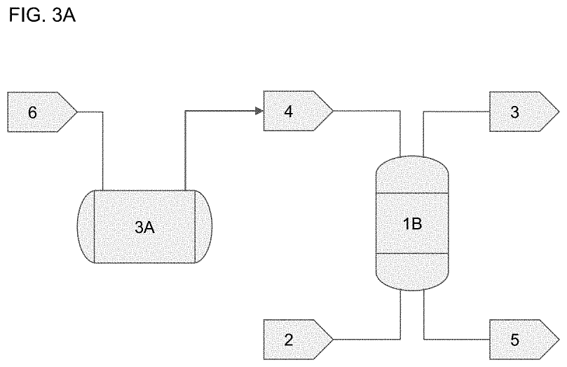

FIG. 2A is a pressure-enthalpy diagram for oxygen, illustrating thermodynamic transitions. Two particular transitions, [1] and [2], are illustrated. Transitions [1] and [2] begin at near ambient conditions, i.e. 0.1 MPa (1 bar) and approximately 296 K (23 Celsius); and both transitions complete at the same pressure, i.e. 0.3 MPa. Transition [1] is isothermal, and essentially isoenthalpic in this region of phase space. On the other hand, Transition [2] is isoentropic, and thus realizes approximately 105 K increase in temperature. Alternatively, Transition [2] may be halted at a final pressure of 0.2 Mpa thereby realizing approximately 62 K increase in temperature. The pressure-enthalpy trajectory during dynamic pressure adjustment is in between Transitions [1] and [2], being neither perfectly isothermal or perfectly isoentropic. Ultimately, to attain the highest ratio of captured carbon dioxide to generated carbon dioxide, the pressure rise is minimized. These are illustrative transitions only, and similar for various other reactive sweep gases such as methane. The practitioner skilled in the art will appreciate the need to limit pressure and temperature escalation during dynamic pressure adjustment.

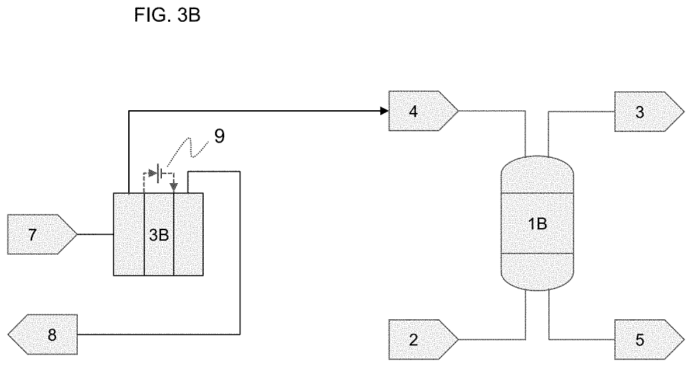

One approach to delivering gaseous oxygen at 1 atm and room temperature is by employing a storage vessel containing liquefied oxygen and offtaking the vapor phase while allowing it to thermally equilibrate with the surroundings as it flows to the stationary phase and thus becomes the reactive sweep gas. FIG. 3A is a schematic diagram of a storage vessel 3A and capture unit 1B. Vessel 3A contains a liquified gas (i.e. at liquid-vapor equilibrium), which is removed as a gas from the top of 3A and transported as Stream 4 to the capture unit 1B. The gas in Stream 4 warms to ambient or near ambient temperature by absorbing heat from the surroundings through the piping, or through a heat exchanger and a waste heat source (no shown). Stream 6 is used to refill the vessel 3A. However, other approaches to attaining oxygen are possible, as mentioned herein, and do not require liquefaction of gases. For example, collection of gaseous oxygen at the anode of a water electrolyzer.

FIG. 3B is a schematic diagram showing gas production from a water electrolysis unit 3B, wherein oxygen gas is generated at the anode side and transferred as Stream 4 at near ambient conditions, and wherein hydrogen gas is generated at the cathode side and transported as Stream 8. Fresh water supplies the electrolyzer as Stream 7. The flow of direct current is shown as Element 9. Commercial scale electrolyzers are available. In another embodiment, Stream 8 (hydrogen) is directed toward Vessel 1B while the oxygen stream is directed elsewhere.

In accordance with yet another aspect of the presently disclosed inventive concepts, a method of executing dynamic pressure adjustment of reactive sweep gas includes employing two vessels connected by a U-tube and containing a non-volatile fluid such as oil, wherein the first vessel is connected to a pressurized source such as pipelined natural gas and wherein the second vessel is connected to a volume of reactive sweep gas, such that the non-volatile liquid prevents mixing of gases and acts as a hydraulic mechanism for pressurizing the reactive sweep gas at a programmed rate controlled by sensors and actuators. In another embodiment, a single axis piston separates the vessels in lieu of the fluid-filled U-tube.

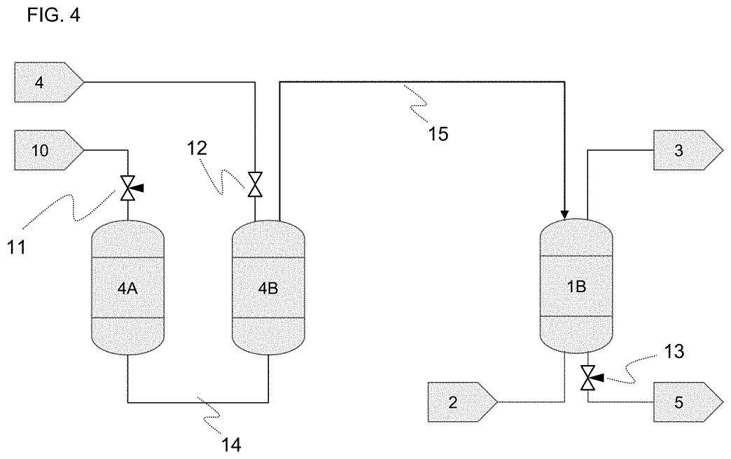

FIG. 4 is a schematic diagram showing a dynamic pressure adjustment system that employs a high-pressure gas such as pipelined natural gas (Stream 10) to apply pressure hydraulically to a volume of reactive sweep gas that is downstream of Valve 12 and upstream of Valve 13. The system includes two vessels 4A and 4B connected by a U-tube 14, which contains a non-volatile fluid such as oil. The non-volatile fluid fills a significant portion of vessels 4A and 4B while leaving vapor space that connects to streams 10 and 4 respectively. First, reactive sweep gas at ambient conditions is suppled via Stream 4 to the volume in the pipe 15, then valve 12 closes. Metering valve 11 opens, applying pressure to the gas in pipe 15. Metering valves 11 and 13 control the pressure and flow rate of reactive sweep gas in Vessel 1B.

In accordance with yet another aspect of the presently disclosed inventive concepts, a method of regenerating a liquid phase containing captured constituents includes contacting said liquid phase with a reactive sweep gas. The contacting of phases occurs by bubbling the reactive sweep gas through the liquid phase; alternatively, the liquid phase may be atomized and dispersed through the reactive sweep gas phase prior to a collection step that removes the regenerated liquid. The liquid phase is a solvent such as a hydroxide solution such as potassium hydroxide, an amine solution such as ethanolamine, ocean water, an ionic liquid, or another liquid that has a physical and/or chemical affinity for the captured constituents. The regeneration may be conducted non-thermally, but in practical cases the liquid phase is heated in order to increase the driving force for removal of captured constituents. The temperature of the reactive sweep gas may equal ambient temperature, or it may be elevated to match the solvent's temperature. A chemical engineering practitioner that is skilled in the art would be capable of designing a variety of gas-liquid contactors to execute the described regeneration.

In accordance with yet another aspect of the presently disclosed inventive concepts, a method of disguising captured constituents includes chemically converting the spent reactive sweep gas, i.e. the reactive sweep gas containing the captured constituents that transferred from a stationary or liquid phase by means of another method. The chemical conversion includes premixing the spent reactive sweep gas with either a fuel or an oxidizer as appropriate to enable a stoichiometric or near stoichiometric conversion of reactive sweep gas, and hence converting the reactive constituents of the spent reactive sweep gas to either an oxidized or reduced form. In one approach, the reactive sweep gas is oxygen and thus the said premixing requires addition of fuel that converts the oxygen to water while generating byproduct carbon dioxide. In another approach, the reactive sweep gas is a hydrocarbon fuel and thus the said premixing requires the addition of an oxidizer that converts the fuel to carbon dioxide and water. In one embodiment, the reactive sweep gas is a hydrocarbon fuel; the spent reactive sweep gas is a mixture of hydrocarbon, carbon dioxide, and moisture; and the chemical conversion produces a final gas mixture of carbon dioxide and moisture wherein the carbon dioxide molecules are indistinguishable—i.e., it is impossible to determine whether the origin of their carbon atoms is the fuel or the carbon dioxide in the initial spent reactive sweep gas, at least without isotopic measurement—further, the water molecules are similarly indistinguishable, as they originate at the initial capture or the chemical conversion. The chemical conversion may occur by means of conventional combustion, oxycombustion, pressurized oxycombustion, or a fuel cell operation such as a solid oxide fuel cell.

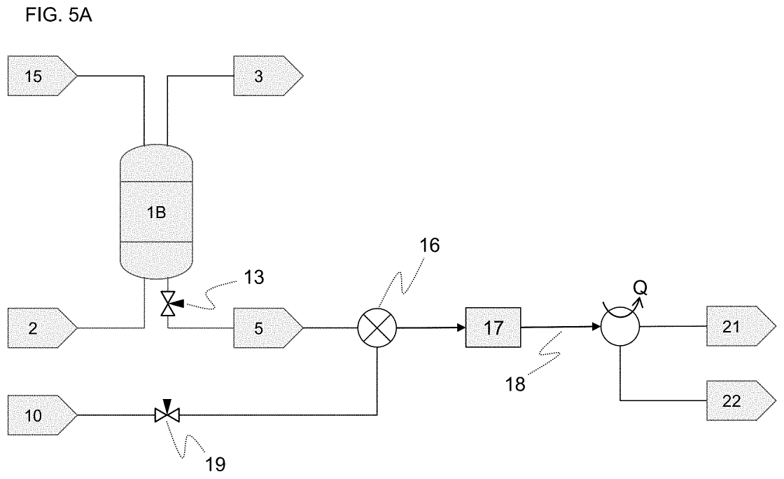

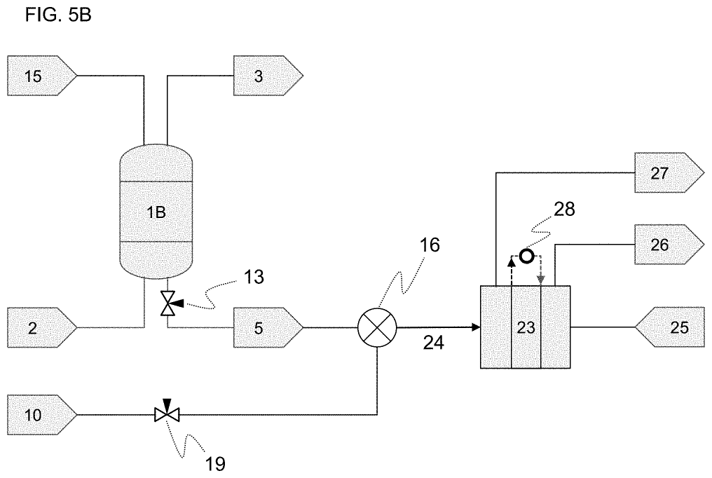

FIG. 5A is a schematic diagram that shows the capture unit 1B, which uses an oxygen stream 15 as a reactive sweep stream in order to produce a spent reactive sweep stream 5 that ultimately is combusted. The spent stream 5 is mixed with pipelined natural gas via stream 10 that is reduced to a suitable pressure through valve 19 prior to mixing within the Mixer 16 in a near stoichiometric ratio that enables subsequent combustion in the combustor 17. Effluent gas from the combustor 17 emerges as Stream 18, which primarily consist of carbon dioxide and water. Stream 18 proceeds to a cooling operation where a heat flow Q is removed, leading to an enriched carbon dioxide stream 21 and a liquid water stream 22. The heat flow may be absorbed by air or by cooling water. This configuration is most suited for integration into a pressurized oxycombustion cycle such as the Allam Cycle—such integration is described in greater detail hereafter.

FIG. 5B is a schematic diagram that shows the capture unit 1B, which uses a methane stream 15 as a reactive sweep stream in order to produce a spent reactive sweep stream 5 that ultimately is converted by reaction in a fuel cell. The spent stream 5 is mixed with pipelined natural gas via stream 10 that is reduced to a suitable pressure through valve 19 prior to mixing within the Mixer 16 in a ratio that enables subsequent reaction at the anode to a methane fuel cell such as a solid oxide fuel cell 23. The anode of fuel cell 23 accepts the hydrocarbon stream 24, which contains the spent reactive sweep gas (methane with captured constituents) and the additional methane of Stream 10. The cathode of fuel cell 23 accepts air from Stream 25. Oxygen depleted air exits as Stream 26. Atomic oxygen migrates across the solid oxide membrane within the fuel cell, and subsequently reacts with the reactive constituents at the anode. Carbon-dioxide and water are enriched at the anode side and they exit as Stream 27, which may contain residual methane depending on the residence time at the anode. In one embodiment, a cooling operation subsequently removes the water of Stream 27. Electricity flows to a resistive load 28. In another embodiment, the methane fuel cell employs a proton transfer membrane, leading to water generation at the cathode side.

In accordance with yet another aspect of the presently disclosed inventive concepts, a method includes chemically converting a spent reactive sweep gas, wherein hydrogen is the original reactive sweep gas. The chemical conversion includes premixing the said spent gas (a mixture of hydrogen, water, and carbon dioxide) with an oxidizer to enable a stoichiometric or near stoichiometric conversion, hence converting the hydrogen of the spent reactive sweep gas to water, which can be removed to yield a final purified carbon dioxide product stream. In one embodiment, the hydrogen is produced by electrolysis. In another embodiment, the oxidizer is air and therefore the final product stream is nitrogen enriched with carbon dioxide. In one use case, the nitrogen with carbon dioxide product stream is used to support plant growth in a greenhouse.

In accordance with yet another aspect of the presently disclosed inventive concepts, a method includes chemically converting a spent reactive sweep gas, wherein carbon monoxide is the original reactive sweep gas. The chemical conversion includes premixing the said spent gas (a mixture of carbon monoxide, water, and carbon dioxide) with an oxidizer to enable a stoichiometric or near stoichiometric conversion, hence converting the carbon monoxide of the spent reactive sweep gas to carbon dioxide, yielding a moist carbon dioxide stream that can be dehydrated through condensation. In one embodiment, the carbon monoxide is produced by electrolysis. In another embodiment, the oxidizer is air and therefore the final product stream is nitrogen enriched with carbon dioxide. In one use case, the nitrogen with carbon dioxide product stream is used to support plant growth in a greenhouse.

In accordance with yet another aspect of the presently disclosed inventive concepts, a method includes chemically converting a spent reactive sweep gas, wherein synthesis gas is the original reactive sweep gas. The chemical conversion includes premixing the said spent gas (a mixture of carbon monoxide, carbon dioxide, water, and hydrogen) with an oxidizer to enable a stoichiometric or near stoichiometric conversion, hence converting the carbon monoxide and hydrogen of the spent reactive sweep gas to carbon dioxide and water, respectively, yielding a moist carbon dioxide stream that can be dehydrated through condensation. In one embodiment, the carbon monoxide is produced by electrolysis. In another embodiment, the oxidizer is air and therefore the final product stream is nitrogen enriched with carbon dioxide. In one use case, the nitrogen with carbon dioxide product stream is used to support plant growth in a greenhouse.

In accordance with yet another aspect of the presently disclosed inventive concepts, a process for transferring carbon dioxide includes capturing carbon dioxide from a gas phase by means of using a stationary or liquid phase, non-thermally regenerating the stationary or liquid phase by means of contact with a reactive sweep fluid thus forming a spent reactive sweep fluid, chemically converting the spent reactive sweep fluid to carbon dioxide and water in the absence of nitrogen, removing the moisture physically by cooling, and thus yielding an essentially pure carbon dioxide product. The pure carbon dioxide product consists of the initially captured carbon dioxide and the generated carbon dioxide. In another embodiment, the disclosed dynamic pressure adjustment method is included within the process in order to maximize the ratio of captured carbon dioxide to generated carbon dioxide in the final product. In yet another embodiment, the spent reactive sweep fluid is chemically converted by ordinary combustion with air, ultimately yielding a nitrogen stream that is enriched with carbon dioxide, which comprises captured and generated carbon dioxide molecules. In yet another embodiment, the spent reactive sweep fluid is chemically converted at the anode of a fuel cell, as in a solid oxide fuel cell using an anion exchange membrane allowing migration of oxygen atoms from the cathode, which is in contact with air. In one use case, the carbon dioxide is captured from regular air. In another use case, the carbon dioxide is captured from a building's HVAC exhaust. In yet another use case, the carbon dioxide is captured from the flue gas of ordinary combustion. In yet another use case, the carbon dioxide is captured from shifted synthesis gas.

In accordance with yet another aspect of the presently disclosed inventive concepts, a process of transferring moisture includes capturing moisture from a gas phase by means of using a stationary or liquid phase, non-thermally regenerating the stationary or liquid phase by means of contact with a reactive sweep fluid thus forming a spent reactive sweep fluid, chemically converting the spent reactive sweep fluid to carbon dioxide and water (with or without the presence of nitrogen), and venting the moist gas. In another embodiment, the moist gas is cooled to collect the water and the residual gas is vented. In one use case, the spent reactive sweep gas is combusted with air at a cook stove, while the initial moisture capture serves to dehumidify the incoming air to an air conditioning system. A chemical engineering practitioner would be able to design a condensation system and tank for collecting liquid water, and therefore such a system and unit operation are not illustrated or further described herein.

In accordance with yet another aspect of the presently disclosed inventive concepts, a method of operation includes capturing constituents from a gas phase by flowing the gas upward over a sorbent such that it attains a fluidized bed or bubbling bed configuration, subsequently directing flow in the downward direction to attain a packed bed configuration, replacing the initial gas phase with a reactive sweep gas that continues to flow downward, and switching the gas phase composition and direction of flow back to the original state to repeat the cycle. In one embodiment, the packed bed configuration attained through downward flow of reactive sweep gas enables the dynamic pressure adjustment method; while the fluidized or bubbling bed configurations enhance the efficiency of gas flow during the initial capture. In another embodiment, the bed configuration remains packed regardless of the sweep gas or direction of flow.

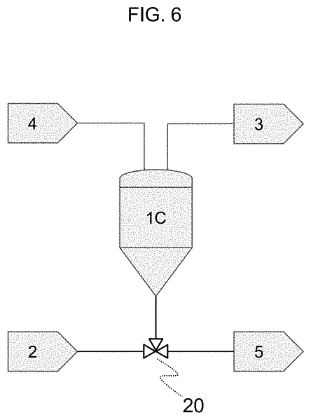

FIG. 6 is a schematic diagram of a capture unit, i.e. Element 1C, which is enabled for bidirectional gas flow through a stationary phase and for full fluidization. Element 1C is also known as Vessel 1C and it contains a confined stationary phase of sorbent that becomes a fully fluidized bed due to the upward flow of inlet gas stream 2 as well as the changing diameter of Vessel 1C. Stream 2 delivers an initial gas containing targeted constituents to the stationary phase, and Stream 3 removes a gas that is leaner in targeted constituents until the stationary phase becomes saturated and the composition of Streams 2 and 3 become identical. After that time, Streams 2 and 3 are closed using valves (not shown), and then Streams 4 and 5 are opened to allow the flow of reactive sweep gas in the downward direction. The transition from upward flow to downward flow reduces the macro-scale porosity of the stationary phase, creating more resistance to flow and thereby increasing the pressure drop across the stationary phase. Three-way valve 20 assists gas switching when the gas flow reverses.

When the inventive concepts disclosed herein are applied to the removal of carbon dioxide from air, the system or systems are referred to as DAC systems or Post-Emission Capture (PEC) systems interchangeably herein. Further, the term Allam cycle is used generally to include oxygen fueled cycles including the Allam-Fetvedt cycle.

Allam Cycle Integration

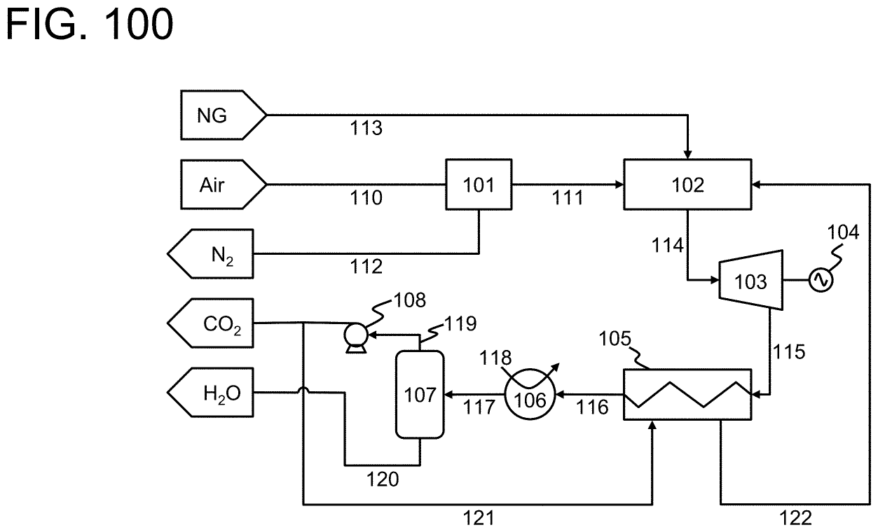

FIG. 100 is a simplified block flow diagram of a gas-fed Allam Cycle. Natural Gas (NG) stream 113 flows to the combustor 102, where it burned in a mixture of oxygen (O₂) and carbon dioxide (CO₂). The combustor 102 receives the CO2-rich stream 122 through recycling from downstream within this process. An Air Separation Unit (ASU) 101 produces the oxygen-rich stream 111 for combustor 102, and the nitrogen-rich stream 112, from the initial Air stream 110.

The combustor 102 delivers the high-temperature combustion mixture 114 that is used to spin the expander 103 and thus produce power through the generator 104. The effluent gas stream 115 from the expander 103 exchanges heat with the produced CO2 stream 121 by means of the heat exchanger 105. The cooler effluent gas stream 116 is cooled further by the chiller 106 in order to condense and separate moisture via the separator 107. CO2-rich product stream 119 is pumped for delivery and for recycling via the CO2-recycle stream 121.

Optionally, alternative systems for oxygen production exist and may become more advantageous than the ASU system 101, including but not limited to systems that employ the electrolysis of water or the electrochemical reduction of CO2.

Optionally, a fraction of the CO2-rich stream 122 could be relayed to the expander 103 rather than to the combustor 102.

Optionally, NG stream 113 may come from a biogenic source, a natural gas pipeline, or a source of methane hydrates. The pressure of NG is in the range of 1 atmosphere to hundreds of atmospheres, depending on the source.

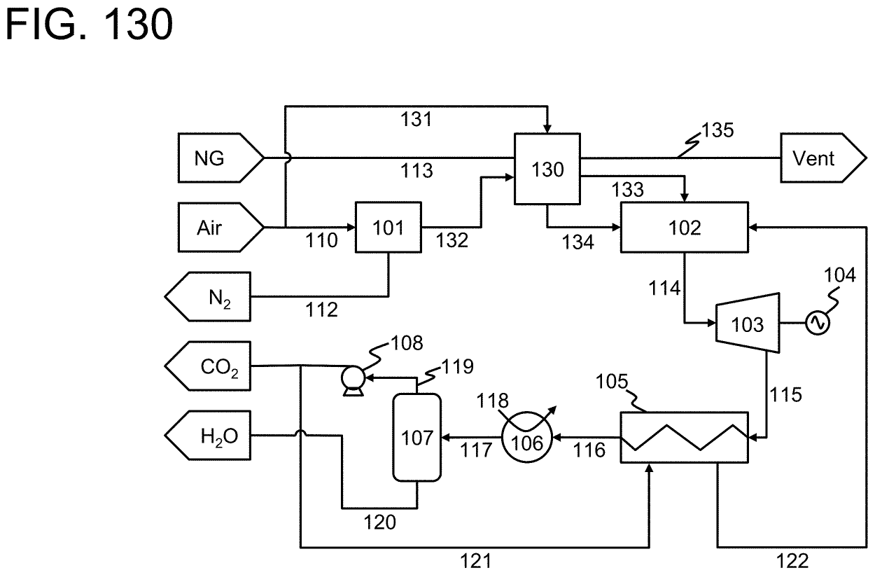

FIG. 130 is a simplified block flow diagram of a gas-fed Allam Cycle that is modified by the addition of Post-Emission Capture (PEC) system 130. The PEC system 130 executes the aforementioned capture and regeneration methods that employ reactive sweep gases.

As illustrated, all of the NG stream 113 and oxygen stream 132 are diverted to PEC system 130. In other embodiments, a slip stream of 113 and 132 may be diverted to 130. In a highly preferred embodiment, the PEC system receives air and oxygen only, and it delivers a final mixture of CO2-O2 at a pressure sufficient to insert into the CO2 recycle stream 122 that is relayed to the combustor 102 and requires a compressor (not shown).

Air stream 131 is diverted to PEC system 130. In another embodiment, an independent air stream may be used. In other embodiments, a dehydrated air stream may be used as stream 131. Yet in other embodiments, dry air from the ASU 101 may be diverted to 130.

The fans that create airflow for the ASU system 101 are included within 101 and are responsible for the flow of air stream 110 without effect on 131. In another embodiment, air in stream 131 is pulled into 130 by natural convection that is driven downstream. Optionally, fans may be used to assist air flow in stream 131, which will otherwise be driven by the natural convection that is created within the PEC system 130 as described herein.

The natural gas feed (NGF) stream 133 and the oxygen feed (OF) stream 134 for the combustor 102 are produced by the PEC system 130. The vent stream 135 returns air to the environment.

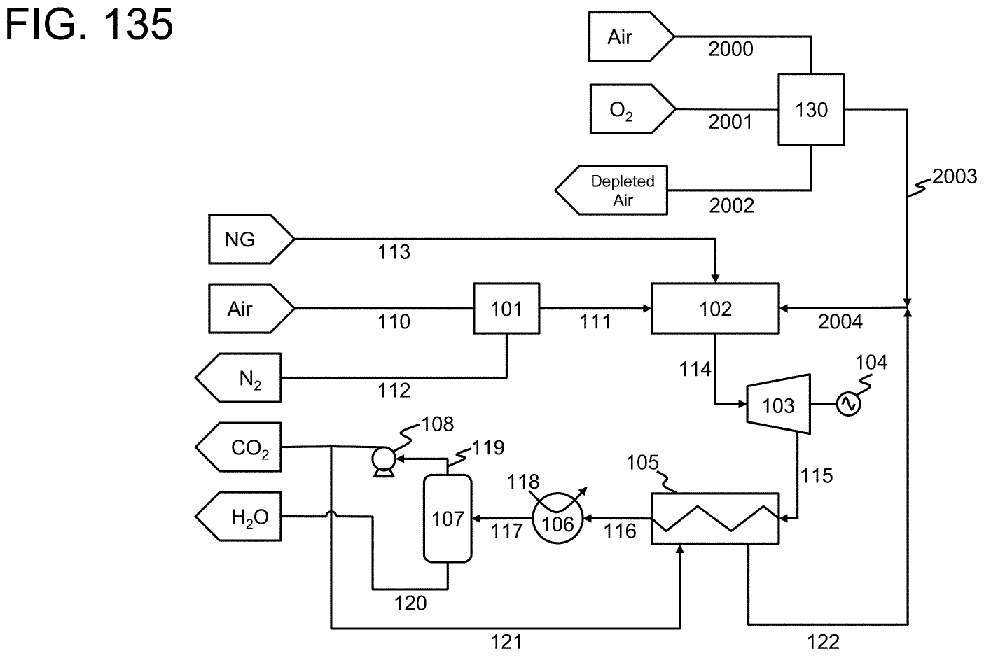

FIG. 135 is a simplified block flow diagram of a modified gas-fed Allam Cycle that is further modified by the addition of PEC system 130 in a highly preferred embodiment. The PEC system receives air stream 2000 and oxygen stream 2001, and it delivers a CO2-O2 stream 2003 at a pressure sufficient to insert into the CO2 recycle stream 122 that is relayed as stream 2004 to the combustor 102. This requires at least one compressor (not shown). The PEC system emits an air stream 2002 that is depleted in CO2. In the most preferred embodiments (for gas-fed and coal-fed Allam cycles), the PEC system receives air and oxygen only and delivers a CO2-O2 stream for insertion into one of the following streams: 122 (as illustrated), 111 (oxygen), 113 (fuel).

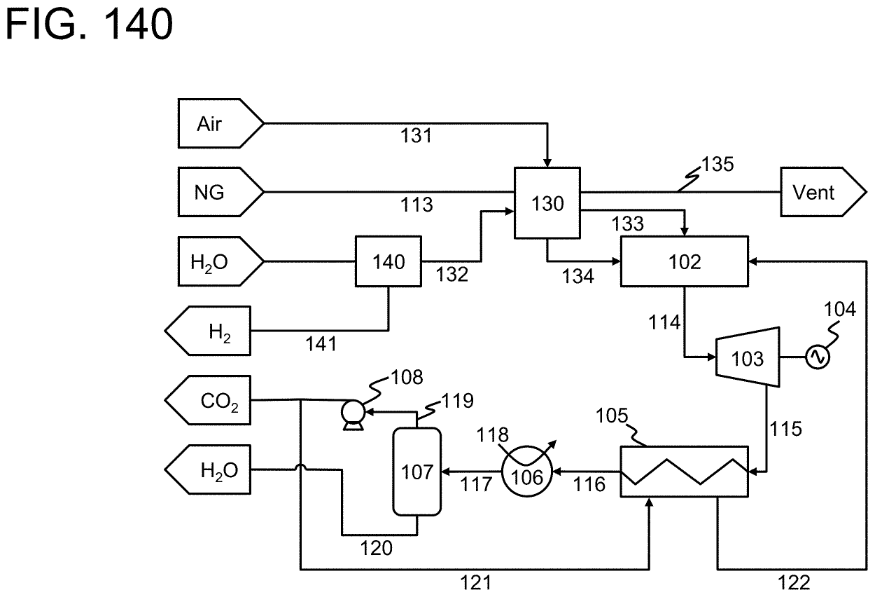

FIG. 140 is a simplified block flow diagram of a modified gas-fed Allam Cycle that is further modified by the addition of PEC system 130. The Allam cycle is modified by replacing the ASU system with the electrolyzer system 140, which produces the oxygen-rich stream 132 and the hydrogen-rich stream 141. Optionally, other oxygen production systems may be employed in lieu of system 140. For example, oxygen may be derived from a CO₂ reduction system that produces carbon monoxide (CO) and oxygen.

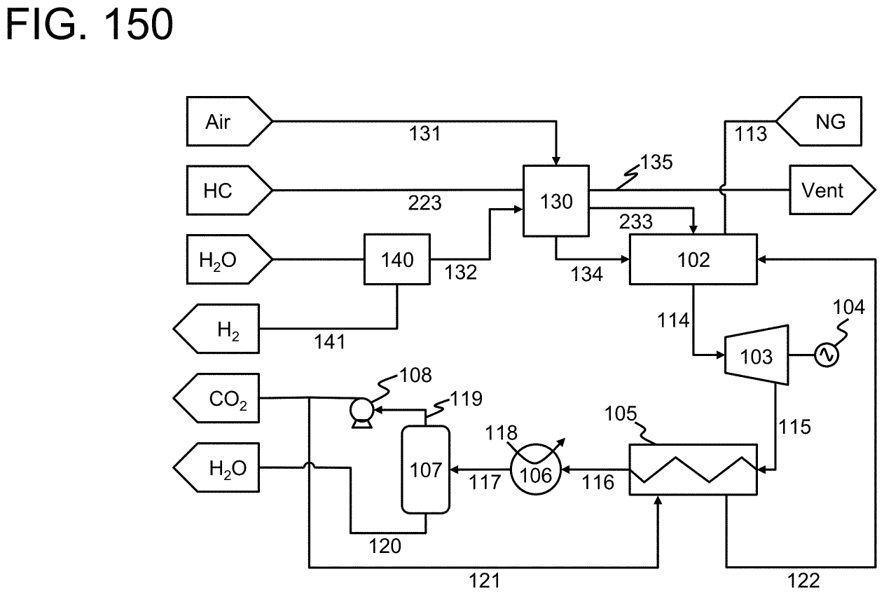

FIG. 150 is a simplified block flow diagram of a modified gas-fed Allam Cycle that is further modified by the addition of an alternative PEC system 130 that accepts a hydrocarbon (HC) inlet stream 223 and that produces a hydrocarbon feed (HCF) stream 233 for the combustor 102. Combustor 102 receives NG stream 113 directly, as in the original gas-fired Allam Cycle process illustrated in FIG. 100. The HC of stream 223 may be in the gas phase, the liquid phase, or a mixed phase.

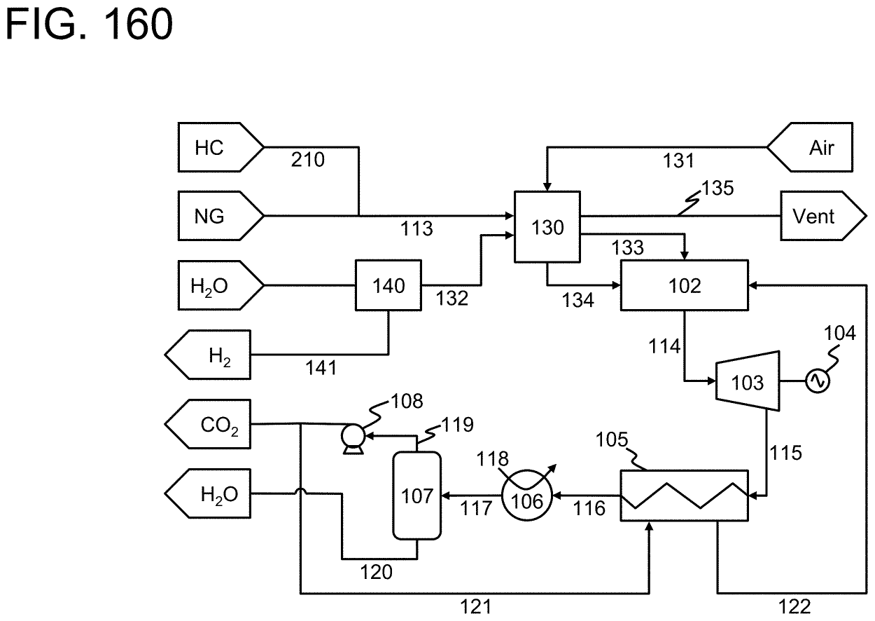

FIG. 160 is a simplified block flow diagram of a modified gas-fed Allam Cycle that is further modified by the addition of an alternative PEC system 130 that accepts the hydrocarbon (HC) stream 210 into the NG stream 113. The HC of stream 210 may be injected periodically into 113 or it may be co-fed steadily with 113. The HC of stream 210 may be in the gas phase, the liquid phase, or a mixed phase.

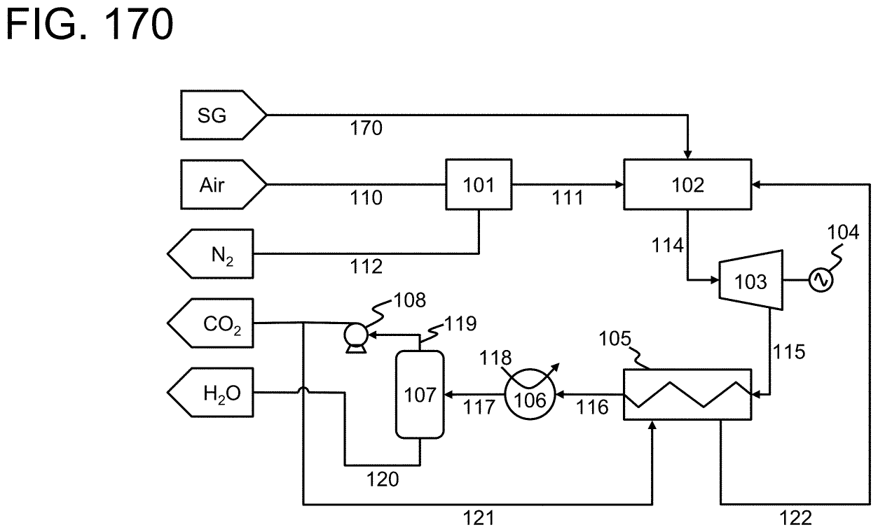

FIG. 170 is a simplified block flow diagram of a portion of the coal-fed Allam Cycle. Coal-derived dry compressed Syngas (SG) stream 170 flows to the combustor 102, where it burned in a mixture of oxygen (O₂) and carbon dioxide (CO₂). The SG stream 170 consists mainly of carbon monoxide (CO) and hydrogen (H₂). The combustor 102 receives the CO2-rich stream 122 through recycling from downstream within this process. An Air Separation Unit (ASU) 101 produces the oxygen-rich stream 111 for combustor 102, and the nitrogen-rich stream 112, from the initial Air stream 110.

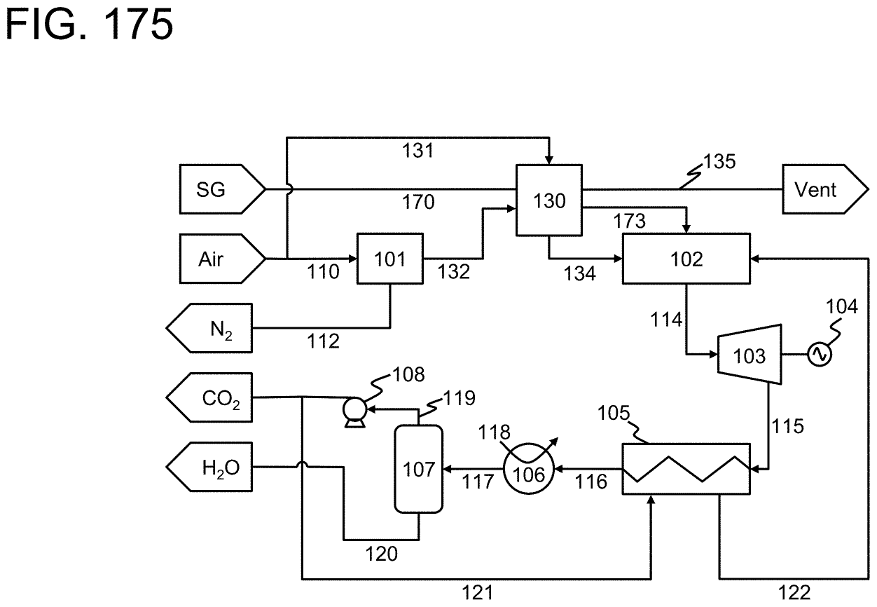

FIG. 175 is a simplified block flow diagram of a portion of a coal-fed Allam Cycle that is modified by the addition of Post-Emission Capture (PEC) system 130. As illustrated, all of the SG stream 170 and oxygen stream 132 are diverted to PEC system 130. In other embodiments a slip stream of 170 and 132 may be diverted to 130.

Air stream 131 is diverted to PEC system 130. The fans that create airflow for the ASU system 101 are included within 101 and are responsible for the flow of air stream 110 without effect on 131. The syngas feed (SGF) stream 173 and the oxygen feed (OF) stream 134 for the combustor 102 are produced by the PEC system 130. The vent stream 135 returns air to the environment.

Optionally, fans may be used to assist air flow in stream 131, which will otherwise be driven by the natural convection that is created within the PEC system 130 as described herein.

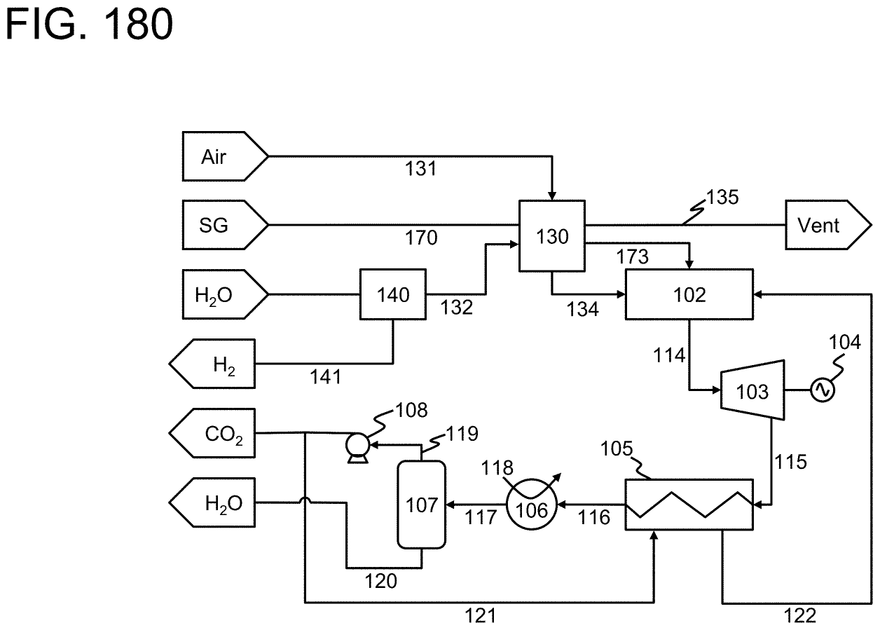

FIG. 180 is a simplified block flow diagram of a portion of a modified coal-fed Allam Cycle that is further modified by the addition of PEC system 130. The Allam cycle is modified by replacing the ASU system with the electrolyzer system 140, which produces the oxygen-rich stream 132 and the hydrogen-rich stream 141. Optionally, other oxygen production systems may be employed in lieu of system 140.

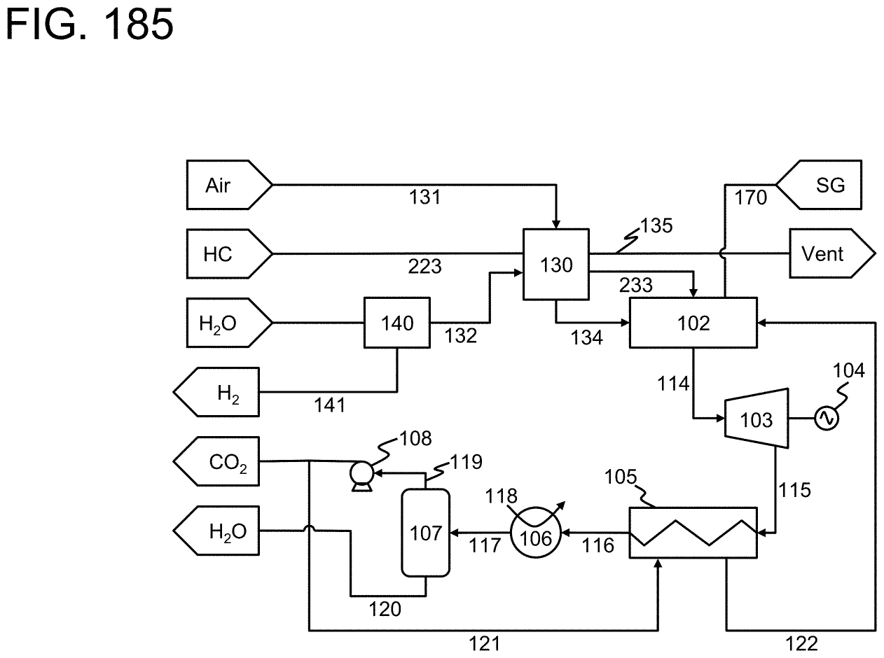

FIG. 185 is a simplified block flow diagram of a portion of a modified coal-fed Allam Cycle that is further modified by the addition of an alternative PEC system 130 that accepts a hydrocarbon (HC) inlet stream 223 and that produces a hydrocarbon feed (HCF) stream 233 for the combustor 102. Combustor 102 receives SG stream 170 directly, as in the original coal-fired Allam Cycle process partially illustrated in FIG. 170. The HC stream 223 may be a liquid phase, gas phase, or mixed phase.

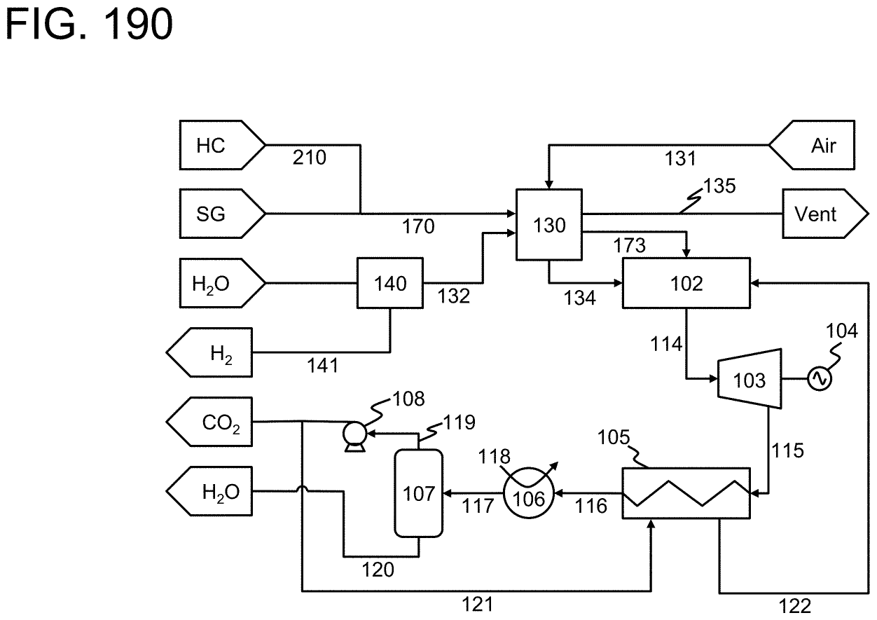

FIG. 190 is a simplified block flow diagram of a portion of a modified coal-fed Allam Cycle that is further modified by the addition of an alternative PEC system 130 that accepts the hydrocarbon (HC) stream 210 into the SG stream 170. The HC of stream 210 may be injected periodically into 170 or it may be co-fed steadily with 170. The HC stream 210 may be a liquid phase, gas phase, or mixed phase.

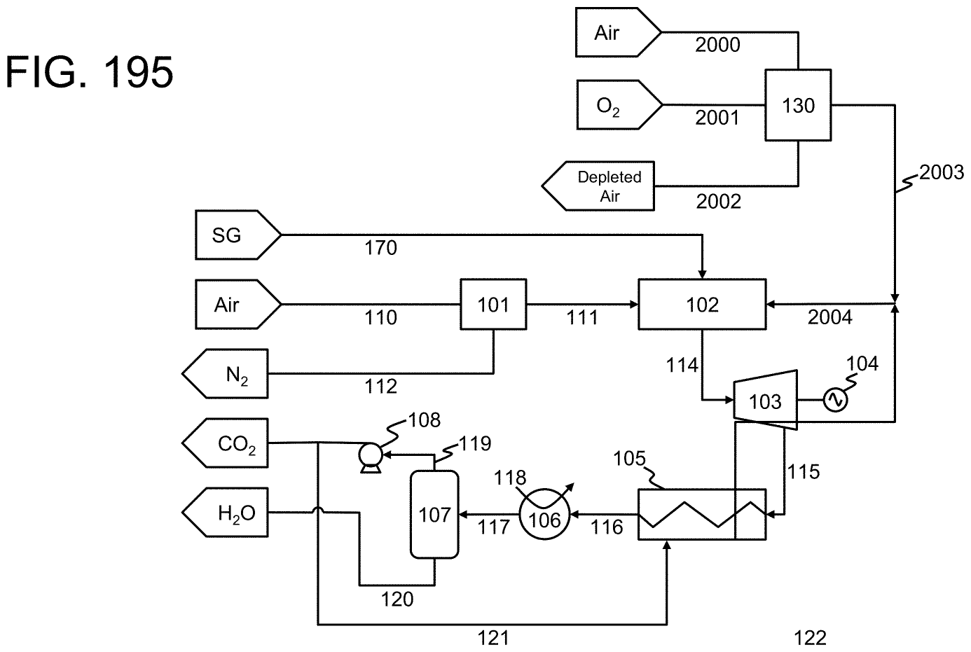

FIG. 195 is a simplified block flow diagram of a portion of a modified coal-fed Allam Cycle that is further modified by the addition of an alternative PEC system 130 in a highly preferred embodiment. The PEC system receives air stream 2000 and oxygen stream 2001, and it delivers a CO2-O2 stream 2003 at a pressure sufficient to insert into the CO2 recycle stream 122 that is relayed as stream 2004 to the combustor 102. This requires at least one compressor (not shown). The PEC system emits an air stream 2002 that is depleted in CO2. In the most preferred embodiments (for gas-fed and coal-fed Allam cycles), the PEC system receives air and oxygen only and delivers a CO2-O2 stream for insertion into one of the following streams: 122 (as illustrated), 111 (oxygen), 170 (fuel).

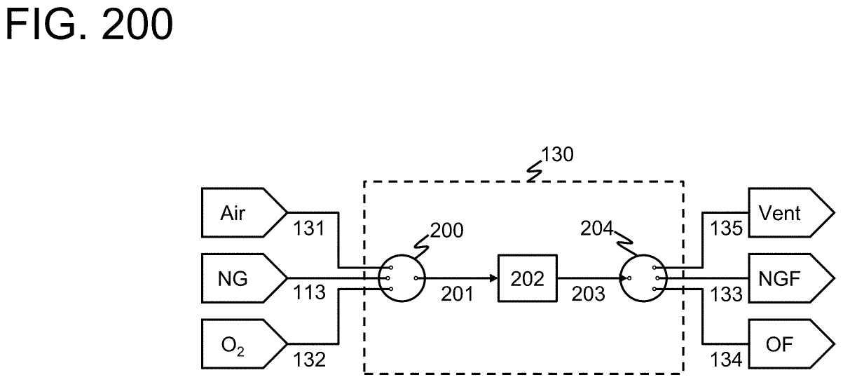

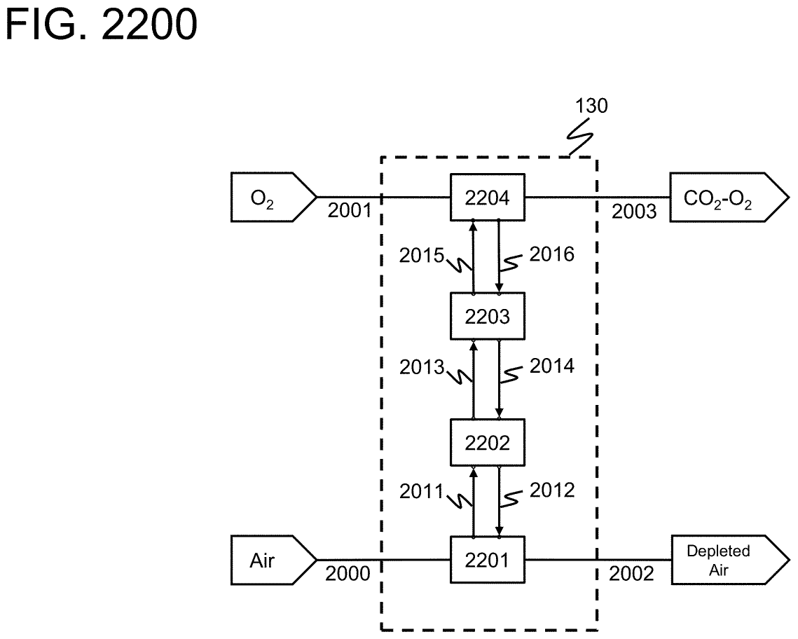

FIG. 200 illustrates the inputs to and subsystems of PEC system 130 which accepts fuel. In preferred embodiments, the fuel streams 113 and 133 are absent. A switching valve 200 is customized to direct one of the input streams (113, 131, 132) toward the capture subsystem 202—the selected input stream is relayed toward subsystem 202 via stream 201. Stream 203 emerges from capture subsystem 202 and is directed by switching valve 204 to one of the exit streams (133, 134, 135). Other embodiments may have a different number of input streams or exit streams. An alternative preferred configuration is shown in FIG. 2200.

The input streams (113, 131, 132) and the exit streams (133, 134, 135) alternate by means of adjusting switching valves 200 and 204. The adjustment of switching valves is not necessarily executed in phase with respect to time, as described here.

First, in the original state, the Air stream 131 is directed to pass through subsystem 202 and to exit via the Vent stream 135. Generally, in this configuration, the carbon dioxide (CO2) within the air is being sorbed within 202. (However, the sorption of CO2 is enhanced by pressurized NG in the next step—this is described in more detail in a subsequent section.)

Second, the NG stream 113 is directed to pass through subsystem 202, cutting off the Air stream 131. Stream 203 continues to be directed to exit via the Vent stream 135 until NG breakthrough is detected at or in the vicinity of switching valve 204 (hereafter curtailed as “at 204”). The gas detector (not illustrated) can be a thermal conductivity detector or another gas detection approach. When NG breakthrough is detected at 204, stream 203 is directed to exit via the NGF stream 133. Generally, in this configuration, the NG first enhances the CO2 sorption (by elevating the pressure at 202) and then it drives CO2 off of the sorbent phase (solid, fluid, or polymer) in subsystem 202 via cosorption phenomena.

Third, the oxygen stream 132 is directed to pass through subsystem 202, cutting off the NG stream 113. Stream 203 continues to be directed to exit via the NGF stream 133 until oxygen breakthrough is detected at 204. When oxygen breakthrough is detected at 204, stream 203 is directed to exit via the oxygen feed (OF) stream 134. Generally, in this configuration, oxygen eliminates any residual NG in the PEC system 130 to prevent any subsequent emission of greenhouse gas via the Vent stream 135.

To return the system to its original state, the Air stream 131 is directed to pass through subsystem 202, cutting off the oxygen stream 132. Stream 203 continues to be directed to exit via the OF stream 134 until air breakthrough is detected at 204. When air breakthrough is detected at 204, stream 203 is directed to exit via the Vent stream 135. This is the original state.

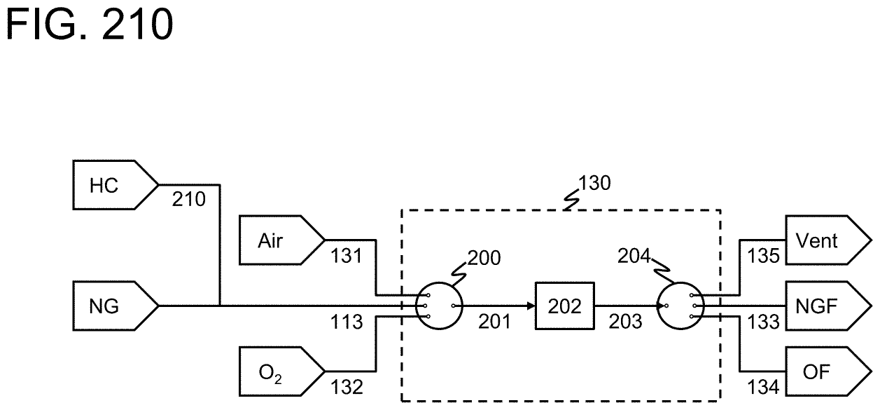

FIG. 210 illustrates the inputs to and subsystems of PEC system 130, with a modified operating procedure than that described in association with FIG. 200. In this approach, a hydrocarbon (HC) pulse is injected into the NG stream 113 by means of HC stream 210. The HC may be a liquid or a gas.

In one embodiment, liquid HC serves to limit turbulent mixing of NG and Air. In another embodiment, HC assists desorption within subsystem 202, as a liquid or after a phase change to a gas. In another embodiment, liquid or gaseous HC serves to assist heat transfer phenomena that occurs within system 130 upon switching from using Air stream 131 to NG stream 113 by means of adjusting valve 200. Yet in another embodiment, HC stream 210 may consist of pulses of two or more different HC constituents that exhibit different phase behavior and thermal properties.

In another embodiment, the HC pulse is injected through a chromatographic switching valve typically used for injections.

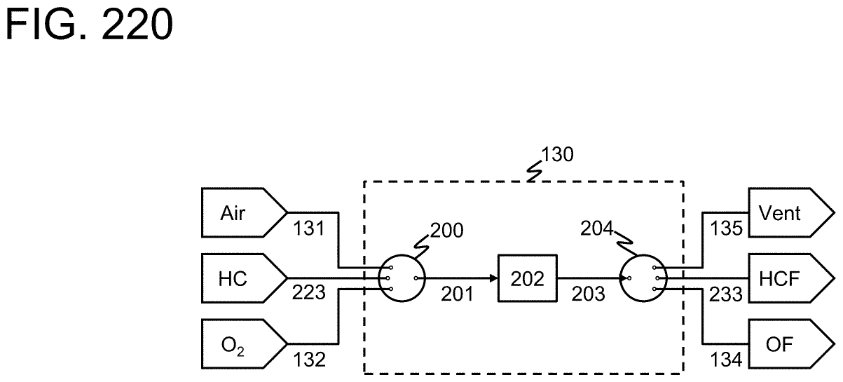

FIG. 220 illustrates the inputs to and subsystems of PEC system 130, with a modified sequence of constituents introduced into system 130. In this approach, a hydrocarbon (HC) stream 223 completely substitutes the natural gas (NG) or syngas (SG) streams used in other embodiments. In one embodiment, the HC stream 223 may consist of NG or SG and other constituents. This Figure is associated with FIG. 150 or FIG. 185.

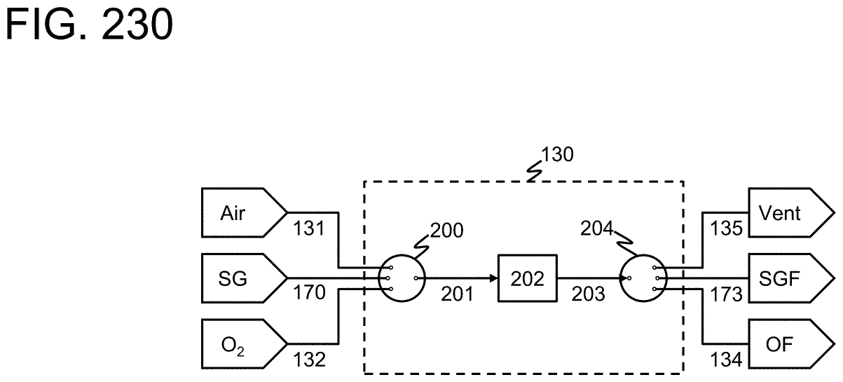

FIG. 230 illustrates the inputs to and subsystems of PEC system 130. Syngas (SG) stream 170 replaces the NG stream 113 in FIG. 200. The general operating procedure is the same as described in association with FIG. 200, substituting SG for NG and SGF for NGF.

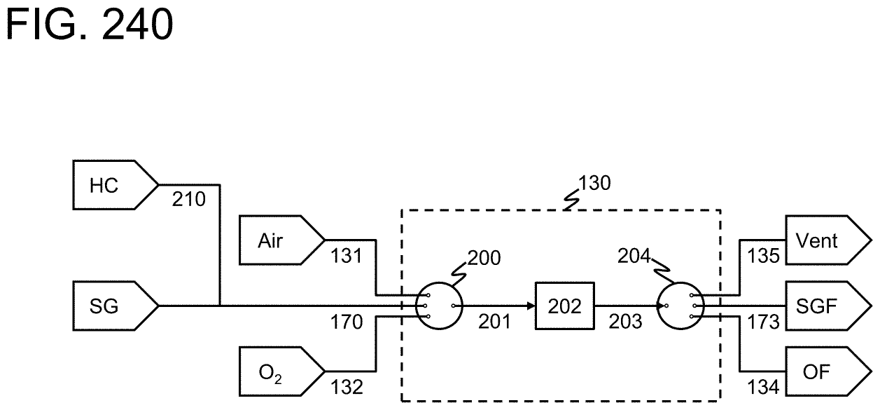

FIG. 240 illustrates the inputs to and subsystems of PEC system 130, with a modified operating procedure. In this approach, a hydrocarbon (HC) pulse is injected into the SG stream 170 by means of HC stream 210. The HC may be a liquid or a gas. Generally, the operating procedure is the same as that described with FIGS. 200 and 210, substituting SG for NG and SGF for NGF.

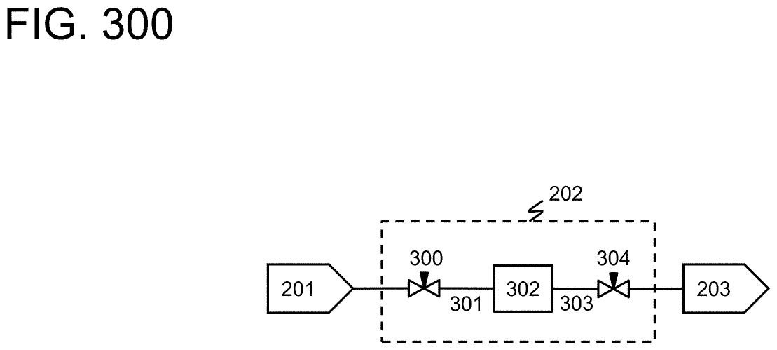

FIG. 300 illustrates an arrangement of subunits for a basic subsystem 202. Metering valves 300 and 304 enable precise flow and pressure control that is essential to switching among operational states. The primary CO2 capture unit resides within subunit 302. Streams 201 and 203 are referenced in other Figures.

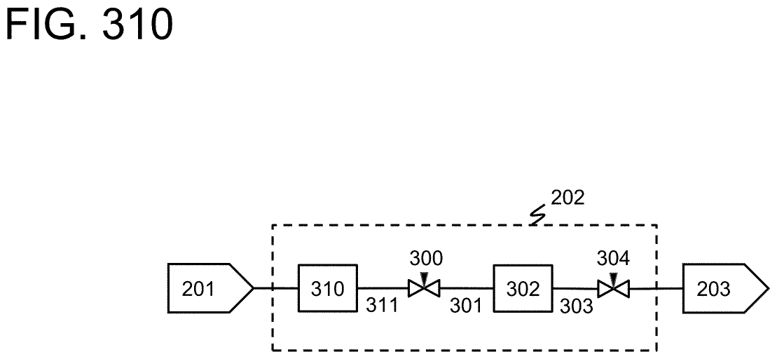

FIG. 310 illustrates an arrangement of subunits for a subsystem 202 that employs a separate dehydration step. Subunit 310 is designed to selectively dehydrate stream 201 so that carbon dioxide is preferentially sorbed within subunit 302. This approach may become most suitable for cases wherein moisture and CO2 sorb too competitively within subunit 302.

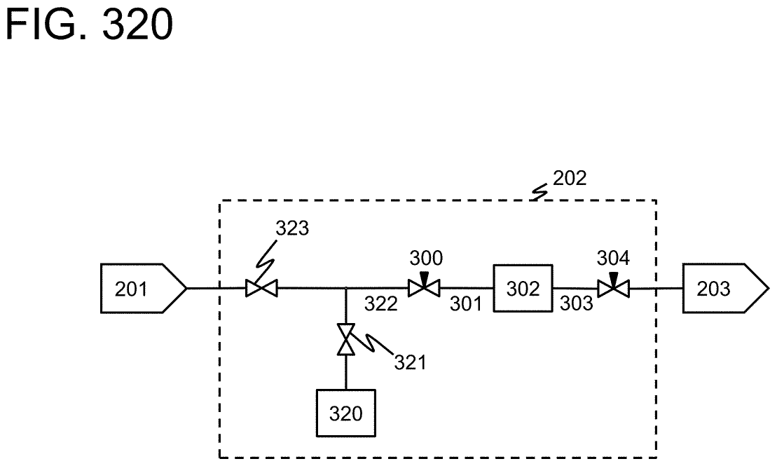

FIG. 320 illustrates an arrangement of subunits for a subsystem 202 that employs a separate dehydration step. Subunit 320 is designed to selectively dehydrate stream 201 so that carbon dioxide is preferentially sorbed within subunit 302. The dehydration would occur by opening valve 321 and closing valve 300, ensuring pressure driven flow of stream 201 toward subunit 320. After dehydration, flow toward subunit 302 would resume by closing valve 323 and opening valve 300.

This approach may become most suitable for cases wherein moisture and CO2 sorb too competitively within subunit 302, when an in-line desiccant creates too much pressure drop, or when alternative methods of moisture removal are sought.

In another embodiment, subunit 320 may be connected to a Vent stream (e.g. 135) to enable regeneration of the desiccant in subunit 320 without relaying moisture through subunit 302.

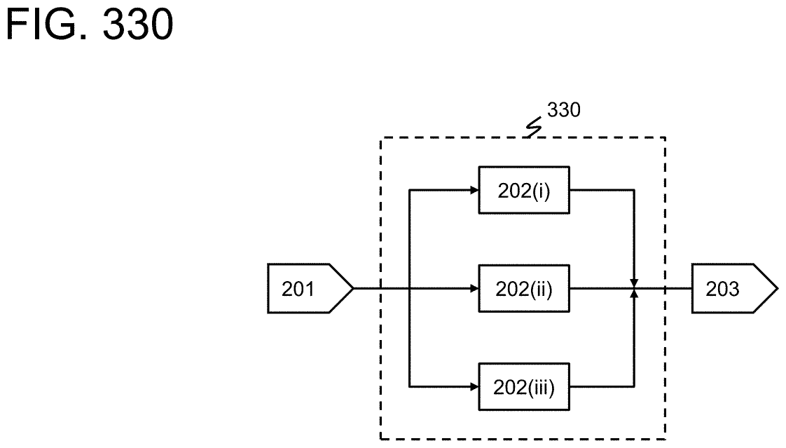

FIG. 330 illustrates a parallel arrangement of subsystems 202 that would enable reduction of pressure loss (pressure gradient) across each subsystem. Sub-systems 202(i), 202(ii), and 202(iii) are independent and presented as examples—any number of parallel subsystems may be employed.

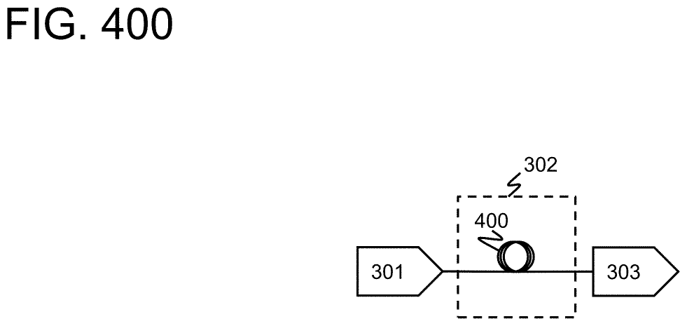

FIG. 400 illustrates one embodiment of a capture subunit 302. Element 400 is a chromatography column (or analog) that consists of a stationary phase adhering to the inner walls of the column. The stationary phase may be polymeric, a solid, or a mixed phase.

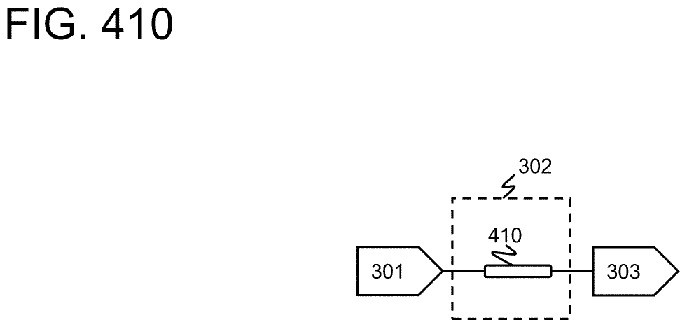

FIG. 410 illustrates another embodiment of a capture subunit 302. Element 410 is a column that consists of a confined stationary phase. The stationary phase may be a packed bed consisting of one or more sorbent materials.

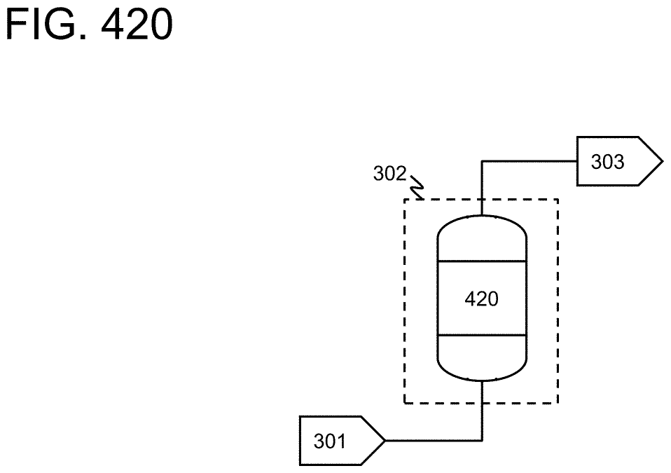

FIG. 420 illustrates another embodiment of a capture subunit 302. Element 420 is a vessel that consists of a confined stationary phase. The stationary phase may be a packed bed consisting of one or more sorbent materials. The bed may operate in a stationary or a bubbling mode. Vessel 420 and Vessel 1 in FIG. 1A are equivalent.

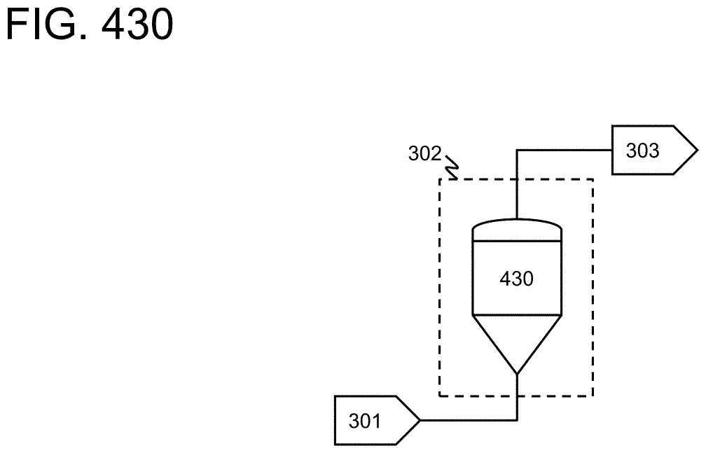

FIG. 430 illustrates another embodiment of a capture subunit 302. Element 430 is a vessel suitable for fluidized bed operation. The bed may consisting of one or more sorbent materials. Optionally, a filter or a hydrocyclone with recycle stream may be inserted between 430 and stream 303 in order to capture any fine solids that escape 430 during fluidized bed operation.

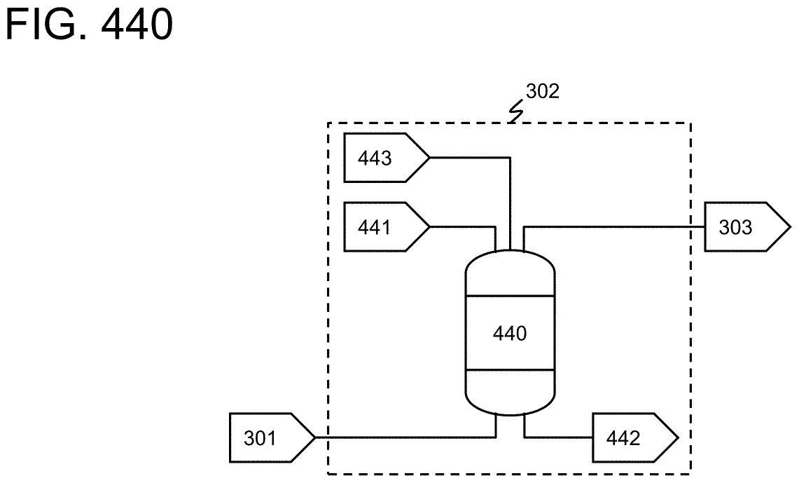

FIG. 440 illustrates another embodiment of a capture subsystem 302. Element 440 is a vessel that contains a liquid or polymer solution that preferentially sorbs carbon dioxide. Stream 441 loads fluid into element 440, and stream 442 drains fluid from 440. Loading or draining may occur periodically or continuously. Stream 443 provides inert gas for padding the vessel and for general pressure management.

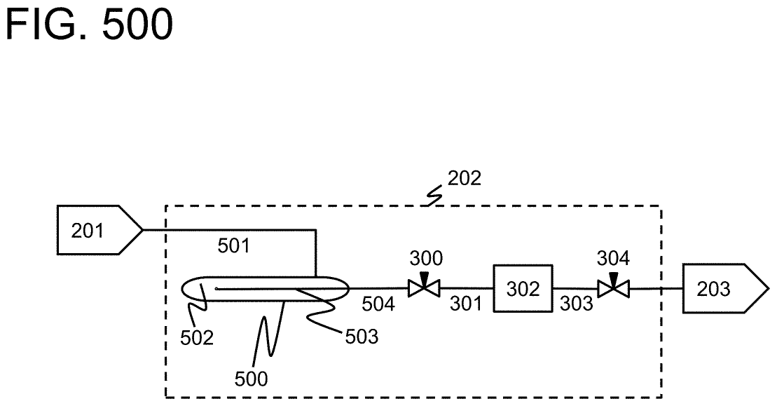

FIG. 500 illustrates an arrangement of subunits for a subsystem 202 that employs a pressure and thermal management method. The method enhances the sorption of carbon dioxide in subunit 302.

Valve 300 closes, isolating subunit 302. Upon introducing pressurized NG (or HC or SG) through the switching valve 200, a pressure pulse propagates at the speed of sound downstream of 200 until valve 300. NG begins to enter through stream 201, filling section 501 and applying pressure to the air originally in sections 501, 502, 503, and 504. The original air compresses until its pressure equals that of the incoming NG, and this causes the flow to stop—the incoming NG pressure decreases when NG is injected as a pulse, but it remains at its original pressure otherwise. The air heats significantly during this compression. Once the air upstream of valve 300 has cooled down, valve 300 opens to establish air flow into subunit 302, which adsorbs carbon dioxide at an elevated partial pressure. Once subunit 302 cools to original temperature and CO2 sorption stops, valve 304 opens to establish flow. NG that followed the compressed air desorbs the CO2 in subunit 302 while pushing the CO2-lean air out through stream 203.

Subunit 500 has a shell and tube design. Section 503 is straight and has a high surface-to-volume ratio that enhances heat transfer between the contents of 503 and the space 502. As illustrated, stream 501 enters at the same end of 500 that stream 503 exits. This compels the gas flow entering 500 via 501 to flow across the outer surface of 503 before entering the inner volume of 503.

In one embodiment, the pressure of air is elevated to 30- to 350-atmospheres due to NG supply at equal or greater pressure. If the air was compressed to 100-atmosphere, this effect enhances the sorption of CO2 because the fugacity of CO2 increases with total pressure—the air appears to contain 4% CO2 by volume instead of 0.04% (i.e. 400 ppm).

In one embodiment, the heat generated due to air compression in subunit 302 is salvaged by heat exchange with the air that exits through Vent 135 on a parallel identical system. This enhances a natural convection drive in the parallel system. In another embodiment, the hot compressed air becomes confined mostly to sections 503 and 504, and its is used to preheat the NG that filled section 502.

In another embodiment, valves 300 and 304 are opened simultaneously to establish flow at higher average pressure in subunit 302.

In another embodiment, valve 300 is opened and valve 304 is closed during the compression of air that occurs with NG introduction. The associated heating regenerates the capture subunit 302, whose void (gas) volume is then purged by opening valve 304. Valve 304 is closed again after the purge, allowing carbon dioxide to sorb within subunit 302 as the air temperature decreases to its original temperature.

In one embodiment, the NG desorbs both carbon dioxide and moisture from 302, carrying both downstream to stream 203. In another embodiment, moisture is captured by a separate desiccant and purged using hot compressed air.

In another embodiment, a pulse of hydrocarbon (HC) liquid precedes the NG in stream 201 in order to minimize turbulent mixing in section 501.

In another embodiment, the HC liquid evaporates within subunit 500 by receiving the heat of air compression—this limits the temperature rise or air. FIGS. 160 and 210 illustrate exemplary systems wherein HC co-feed is used.

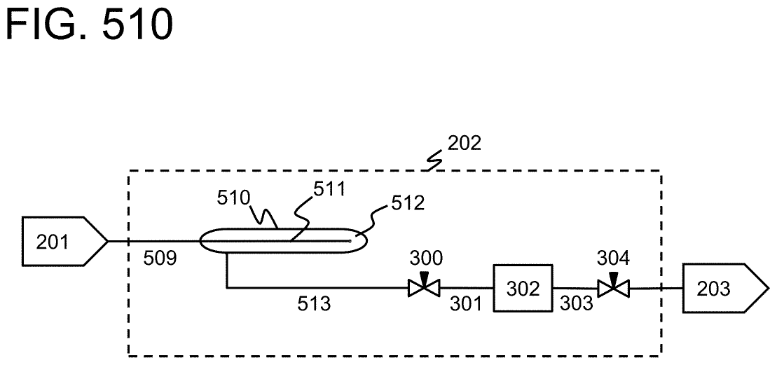

FIG. 510 illustrates an arrangement of subunits for a subsystem 202 that employs an alternative pressure and thermal management method. The method enhances the sorption of carbon dioxide in subunit 302.

Valve 300 closes, isolating subunit 302. Upon introducing pressurized NG (or HC or SG) through the switching valve 200, a pressure pulse propagates at the speed of sound downstream of 200 until valve 300. NG begins to enter through stream 201, filling section 509 and applying pressure to the air originally in sections 509, 511, 512, and 513. The original air compresses until its pressure equals that of the incoming NG, and this causes the flow to stop—the incoming NG pressure decreases when NG is injected as a pulse, but it remains at its original pressure otherwise. The air heats significantly during this compression. Once the air upstream of valve 300 has cooled down, valve 300 opens to establish air flow into subunit 302, which adsorbs carbon dioxide at an elevated partial pressure. Once subunit 302 cools to original temperature and CO2 sorption stops, valve 304 opens to establish flow. NG that followed the compressed air desorbs the CO2 in subunit 302 while pushing the CO2-lean air out through stream 203.

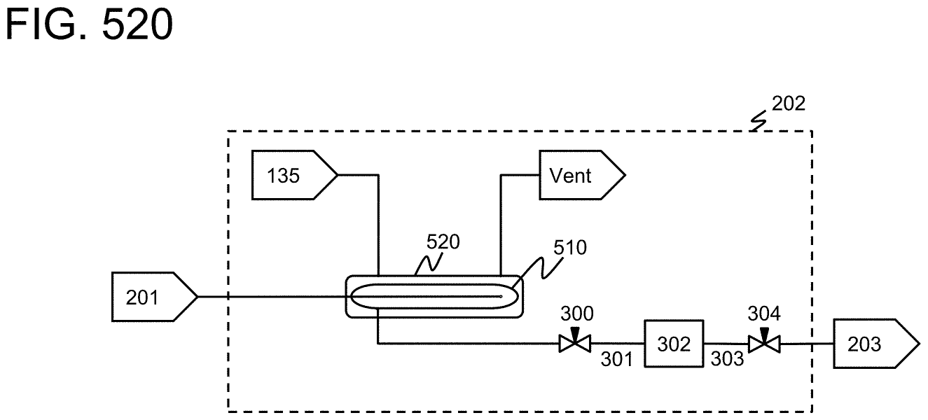

In one embodiment, the hot compressed air becomes confined mostly to sections 512 and 513, and its is used in part to preheat the NG in section 511, and in part to heat the surroundings through the heat exchange surface of subunit 510. In another embodiment, the hot compressed air heats the air exiting a parallel identical system, as illustrated in FIG. 520.

In another embodiment, a pulse of hydrocarbon (HC) liquid precedes the NG in stream 201 in order to minimize turbulent mixing in section 509 and beyond. In another embodiment, the HC liquid evaporates within section 509 and absorbs in part the heat of air compression—this limits the temperature rise of air. FIGS. 160 and 210 illustrate exemplary systems wherein HC co-feed is used.

FIG. 520 illustrates an arrangement of subunits for a subsystem 202 that employs an alternative pressure and thermal management method described in association with FIG. 510. This method is used to transfer heat from hot compressed air across the surface of subunit 510, to air that is being vented from a parallel identical system. This approach enhances the natural convection potential in the parallel system.

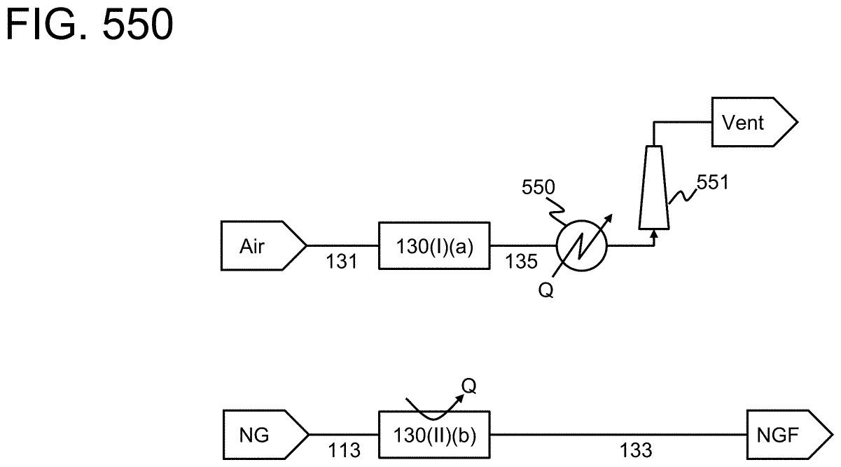

FIG. 550 illustrates the arrangement of parallel systems that utilize the method described in association with FIG. 520 for the purpose of providing natural convection drive.

Air in stream 131 is being pulled through subsystem 130 of system (I), which is in configuration (a). This configuration consists of the operating state before NG (or HC or SG) is introduced. Heat exchanger 550 is used to provide an amount of heat Q to stream 135. Chimney 551 is used to establish the natural convection. Air vents to atmosphere at a higher elevation.

The amount of heat Q is provided from subsystem 130 of system (II), which is in configuration (b). This configuration consists of the operating state after NG (or HC or SG) is introduced, leading to the compression of air and associated temperature rise.

In another embodiment, Q-driven convection may be supplemented or replaced by upstream blowers or otherwise attained pressure from upstream air.

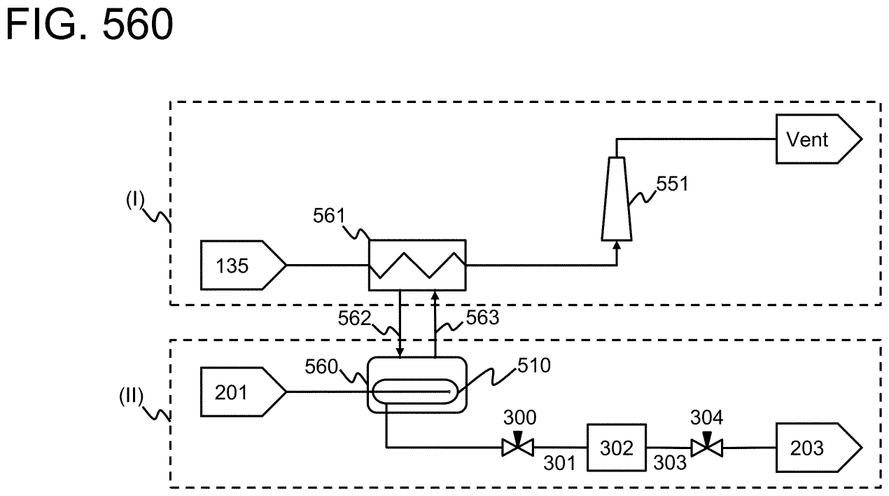

FIG. 560 illustrates the use of a heat pipe for the purpose of transferring heat from system (II) to system (I), in accordance with FIG. 550. The heat pipe consists of an evaporator 560 and a condenser 561. Vapor stream 563 flows up from the evaporator, and condensate stream 562 flows down from the condenser.

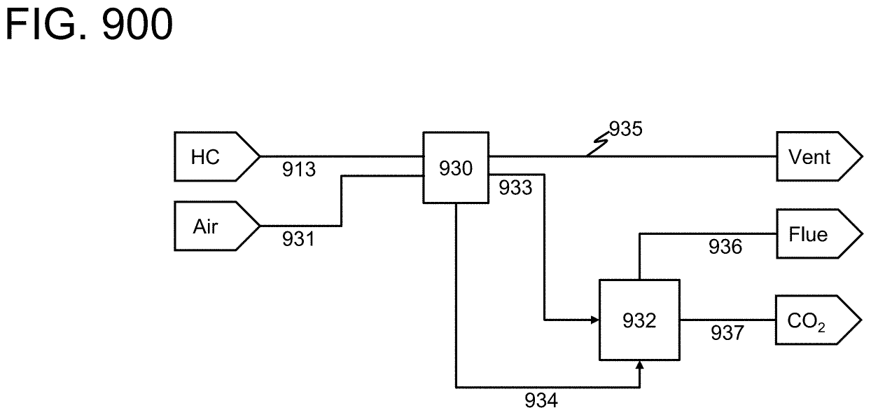

FIG. 900 is a simplified block flow diagram of an alternative Post-Emission Capture (PEC) process that is suitable for a CCS-enabled power plant 932. The power plant may be a gas or a coal fired plant. Hydrocarbon (HC) stream 913 and Air stream 931 are directed to the PEC system 930. The PEC system 930 produces Vent stream 935, hydrocarbon feed (HCF) stream 933, and combustion air (CA) stream 934. The power plant 932 produces a CO2-lean flue gas 936 and a CO2 product stream 937. The HCF stream 933 would be co-fired with the fuel for plant 932.

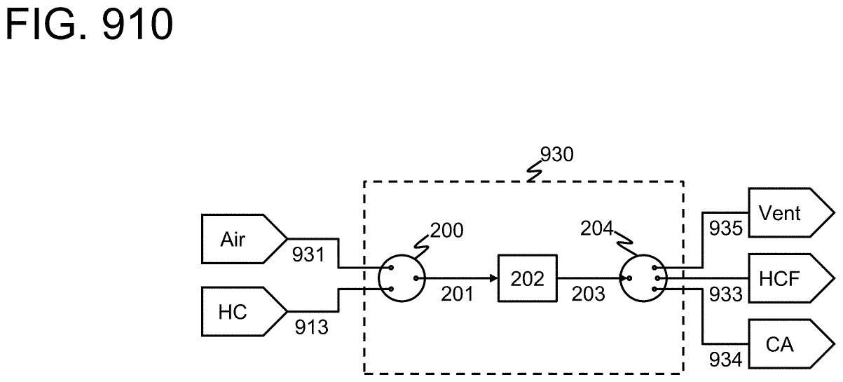

FIG. 910 illustrates the inputs to and subsystems of PEC system 930, which is associated with FIG. 900. The HC stream 913 may be a gas or liquid.

A switching valve 200 is customized to direct one of two input streams (913, 931) toward the capture subsystem 202—the selected input stream is relayed toward subsystem 202 via stream 201. Stream 203 emerges from capture subsystem 202 and is directed by switching valve 204 to one of three exit streams (933, 934, 935). Other embodiments may have a different number of input streams or exit streams.

First, the Air stream 931 is directed to pass through subsystem 202 and to exit via the Vent stream 935. Generally, in this configuration, the carbon dioxide (CO2) within the air is being sorbed (adsorbed or absorbed) within 202.

Second, the HC stream 913 is directed to pass through subsystem 202, cutting off the Air stream 931. Stream 203 continues to be directed to exit via the Vent stream 135 until HC breakthrough is detected at or in the vicinity of switching valve 204 (hereafter curtailed as “at 204”). When HC breakthrough is detected at 204, stream 203 is directed to exit via the HCF stream 933. Generally, in this configuration, the NG drives CO2 off of the sorbent phase (solid, fluid, or polymer) in subsystem 202 via cosorption phenomena.

Third, the air stream 931 is directed to pass through subsystem 202, cutting off the HC stream 913. Stream 203 continues to be directed to exit via the HCF stream 933 until air breakthrough is detected at 204. When air breakthrough is detected at 204, stream 203 is directed to exit via the combustion air (CA) stream 934. Generally, in this configuration, air eliminates any residual HC in the PEC system 930 to prevent any subsequent emissions via the Vent stream 935. After the system 930 has been purged with air, stream 203 is directed to exit via the Vent stream 935.

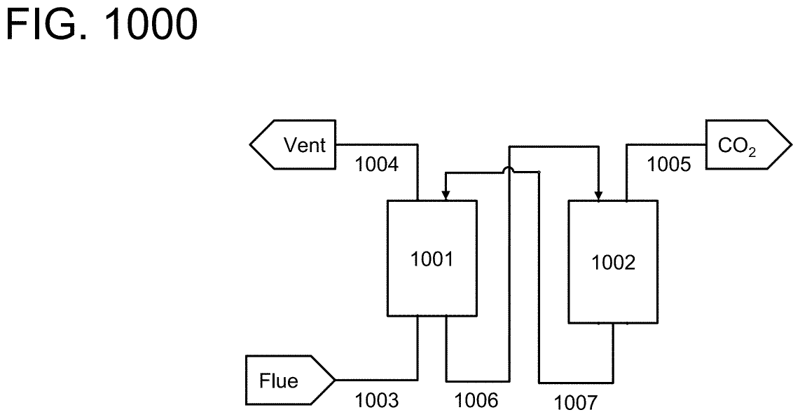

FIG. 1000 is a simplified block flow diagram for a conventional solvent-based carbon dioxide capture process, e.g. a process that uses mono-ethanol amine (MEA). A power plant's flue gas stream 1003 is received by absorber 1001, which emits a lean flue gas in stream 1004. Absorber 1001 receives lean solvent stream 1007 from the regenerator 1002, and it gives a CO2-rich solvent stream 1006 to regenerator 1002. A CO2 rich vapor stream 1005 exits 1002 and is relayed downstream for further processing such as compression or CO2 conversion. Pumps, reboilers/condensers, heat exchangers, and other equipment exist but are not shown.

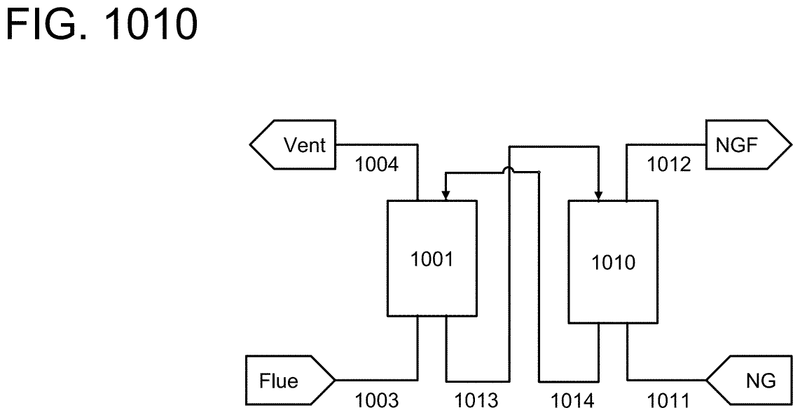

FIG. 1010 is a simplified block flow diagram for a modified solvent-based carbon dioxide capture process, wherein natural gas (NG) stream 1011 is used to desorb CO2 from the regenerator 1010. Regenerator 1010 produces natural gas feed (NGF) stream 1012 for combustion in a CCS enabled process, and it produces CO2-lean capture solvent 1014 for use in the absorber 1001. CO2-rich solvent stream 1013 flows to the regenerator 1010. Both 1001 and 1010 are liquid-gas contactors.

In one embodiment, NG is replaced with a different hydrocarbon gas that is ultimately combusted in a separate CCS-enabled process.

In another embodiment, the NGF stream 1012 takes part in the combustion that produces flue gas stream 1003.

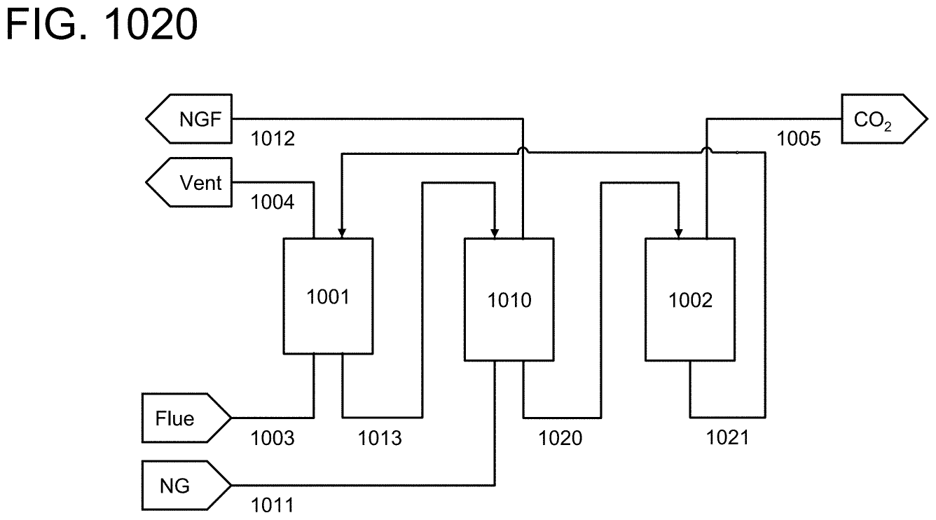

FIG. 1020 is a simplified block flow diagram for a modified solvent-based carbon dioxide capture process, wherein natural gas (NG) stream 1011 is used to partially desorb CO2 from a primary regenerator 1010. Regenerator 1010 produces natural gas feed (NGF) stream 1012 for combustion in a CCS enabled process, and it produces leaner capture solvent 1020 for further regeneration in a conventional regenerator 1002 that is equipped with a reboiler (not shown). The secondary regenerator 1002 produces an even leaner capture solvent for use in the absorber 1001. Both 1001 and 1010 are liquid-gas contactors. Regenerator 1002 includes a reboiler that requires heat input.

In one embodiment, NG is replaced with a different hydrocarbon gas that is ultimately combusted in a separate CCS-enabled process.

In another embodiment, the NGF stream 1012 takes part in the combustion that produces flue gas stream 1003.

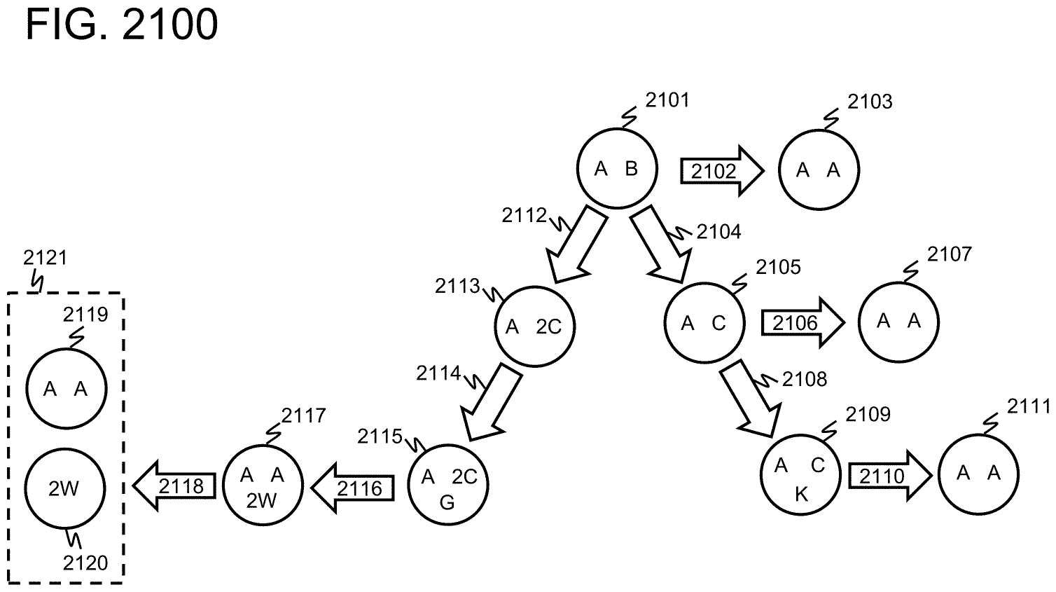

FIG. 2100 is a schematic that illustrates the possibilities for and logic of reactive disguisement. Consider volume 2101 of gas comprising two components (A and B) that need to be separated and where component A is the desired product. The desired outcome is attainment of a volume of gas 2103 that contains component A but not component B. In lieu of an extensive number of physical separation stages with significant energy inputs for regeneration, a reactive disguisement approach 2102 may be taken to chemically convert component B into component A. This is what occurs in Pruet's thermal oxidizer wherein A=H2O and B=H2 (vide supra, US 2005/0284290A1). Unfortunately, this approach (2102) is not possible for DAC or DACPGS processes because the components are A=CO2 and B=N2, and N2 cannot be converted to CO2.

An alternative approach 2104 involves replacing B with another component C, much like the invention of Keefer et al. (vide supra, US 2004/0011198A1), to attain a volume of gas 2105 comprising A and C; and subsequently converting C to A by means of 2106 to attain a volume of gas 2107 that contains component A but not component B. Unfortunately, this approach is not possible for DACPGS when the components are A=CO2 and C=O2 because O2 does not convert to CO2.

An alternative approach 2108 adds carbon (K) to attain a system 2109 comprising A, C, and K. This allows for conversion 2110 wherein C and K react to form A. The coal-fed Allam cycle configuration with a PEC operation as illustrated in FIG. 195 is one such example wherein a volume of air (2101) is transformed sequentially by steps 2104, 2108, and 2110 (water is not illustrated).

In another preferred embodiment that is consistent with the gas-fed DACPGS configuration in FIG. 135, the volume of air (2101) is modified to exchange N2 (component B) for O2 (component C) by means of step 2112 such that the concentration of CO2 (component A) is 33% with the balance being O2 as represented by 2113. The volume 2113 is further modified by introducing methane (G) through 2114 to create a volume 2115 comprising CO2, O2, and CH4. The stoichiometric combustion of gas in oxygen through step 2116 yields a gaseous mixture 2117 comprising CO2 and H2O (W). The mixture 2117 is easily separated by cooling step 2118, which yields two phases: a gas 2119 that is rich in CO2 and a liquid 2120 that is rich in H2O. Collectively, steps 2112, 2114, 2116, and 2118 are the sequence of steps in the DACPGS configuration that is subject of FIG. 135. For example, mixture 2113 represents the mixture in stream 2003; and system 2121 represents the contents of stream 117.

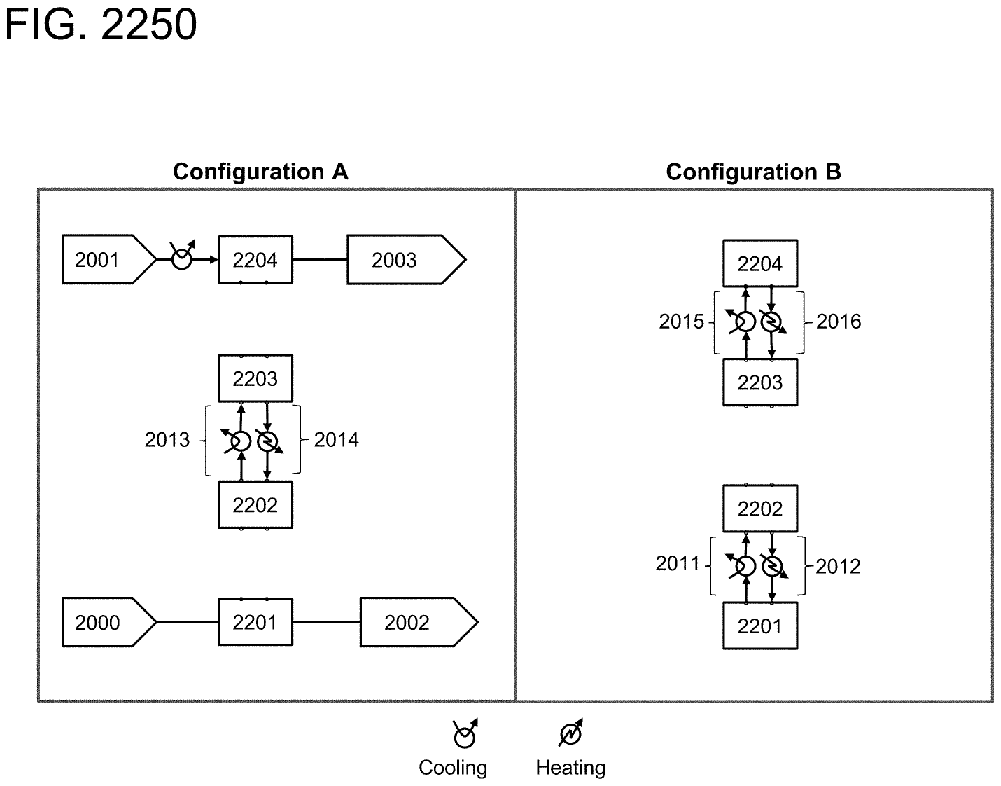

FIG. 2200 is a block flow diagram that illustrates an adsorbent-based DAC system with four stages 2201, 2202, 2203, and 2204. The flows into and out of the system 130 are consistent with the DACPGS configuration in FIG. 135. These stages exchange mass flows with each other in an alternating sequence as described in association with FIG. 2250. Heat exchangers (not shown) provide interstage heating and cooling.

FIG. 2250 is a schematic that shows the sequence of exchanges among the four stages of the adsorbent-based DAC system. The system cycles between configuration A and configuration B. In configuration A, the first adsorbent stage 2201 is loading with CO2 from the air stream 2000; the fourth adsorbent stage 2204 is unloading its CO2 by means of contact with oxygen 2001 at an elevated temperature; and the central two stages are transferring CO2 from the second stage 2202 to the third stage 2203. Heat exchangers for heating and cooling are noted on the schematic. In configuration B, the first adsorbent stage 2201 is transferring the captured CO2 to the second stage 2202; and the third adsorbent stage 2203 is transferring CO2 to the fourth adsorbent stage 2204.

In one embodiment, Zeolite HY HSZ-320 with Si/Al ratio of 5 is the adsorbent for each stage. The parameters of the dual-site Langmuir isotherm for CO2 are: M₁=0.615 mmol/g, b₁=4.04E-9 kPa⁻¹, Q₁=44.222 kJ/mol, M₂=6.733 mmol/g, b₂=4.036E-7 kPa⁻¹ and Q2=23.588 kJ/mol. The functioning system has the following tabulated characteristics upon cycling between 300K (CO2 loading) and 343K (CO2 unloading); and a pressure of 100 kPa throughout.

| Stage or | Mass Sorbent | Reduced Flow | Temp* | CO2 Fraction |
|---|---|---|---|---|
| Stream | [kg] | [m3/unit time] | [K] | [mol/mol] |
| Stage 2201 | 1,020 | | | |
| Stage 2202 | 102 | | | |
| Stage 2203 | 9.62 | | | |
| Stage 2204 | 4.49 | | | |
| 2000 | | 80.7 | 300 | 0.000400 |
| 2001 | | 0.00209 | 343 | 0 |
| 2002 | | 80.7 | 300 | 0.000393 |
| 2003 | | 0.00209 | 343 | 0.330 |
| 2011 | | 6.49 | 300 | 0.00258 |
| 2012 | | 7.42 | 343 | 0.00248 |
| 2013 | | 0.559 | 300 | 0.0160 |
| 2014 | | 0.639 | 343 | 0.0149 |
| 2015 | | 0.0341 | 300 | 0.0880 |
| 2016 | | 0.0390 | 343 | 0.0703 |

*Temperature is reported downstream of the heat exchanger.

The inventive concepts disclosed herein have been presented by way of example to illustrate the features thereof in a plurality of illustrative scenarios, embodiments, and/or implementations. It should be appreciated that the concepts generally disclosed may be implemented in any combination, permutation, or synthesis thereof. In addition, any modification, alteration, or equivalent of the presently disclosed features, functions, and concepts that would be appreciated by a person having ordinary skill in the art upon reading the instant descriptions should also be considered within the scope of this disclosure.

While inventive concepts have been described above, they have been presented by way of example only, and not limitation. Thus, the breadth and scope of the various aspects of the present invention should not be limited by any of the above-described exemplary approaches but should be defined only in accordance with the following claims and their equivalents.

1-22. (canceled)

23. A process for removing CO2 from air; creating a mixture of CO2 and O2; sufficiently concentrating the CO2 while retaining a balance of O2; relaying the CO2-O2 mixture toward the combustor of an oxygen-fueled combustor that is part of a semi-open CO2-based power cycle; combusting the CO2-O2 mixture with a mixture of hydrocarbons; separating, recycling, and exporting the resultant CO2 and H2O as in the semi-open Allam-Fetvedt cycle.
